(19) United States
(12) Patent Application Publication
(10) Pub. No.: US 2012/0185563 A1
(43) Pub. Date: Jul. 19, 2012

(54) NETWORK SYSTEM, VIRTUAL PRIVATE CONNECTION FORMING METHOD, STATIC NAT FORMING DEVICE, REVERSE PROXY SERVER AND VIRTUAL CONNECTION CONTROL DEVICE

(75) Inventors: Fumihiko Sugiyama, Tokyo (JP); Noriyoshi Osumi, Tokyo (JP); Hiroyuki Hanasaka, Tokyo (JP)

(73) Assignee: Springsoft K.K., Tokyo (JP)

(21) Appl. No.: 13/393,839

(22) PCT Filed: Jul. 29, 2011
(86) PCT No.: PCT/JP2011/067430

§ 371 Date: Mar. 2, 2012

(30) Foreign Application Priority Data
Aug. 31, 2010 (JP) 2010-194959

(51) Int. Cl. G06F 15/16

(52) U.S. Cl. 709/217

(57) ABSTRACT

To provide a new network system, a new network connection device and a new reverse proxy device enabling to solve the problems of the conventional VPN and achieve strong security and flexible operability by adding extremely light software and hardware.

After a static NAT forming device has performed authentication with a conductor through a control session, if a terminal makes a connection request to a server in a network existing before a reverse proxy server, the static NAT forming device and a stepping node will set a static NAT, and the reverse proxy server will set a reverse proxy, so that a data session will be formed between the terminal and the server. By configuring a network system in such a manner, it is possible to pass through the firewall to achieve a connection from the terminal to the server in a virtual connection state without causing private address collision.

### TECHNICAL FIELD

The present invention relates to a network system, a virtual private connection forming method, a static NAT forming device, a reverse proxy server and a virtual connection control device.

More particularly, the present invention relates to a new virtual private network system and virtual private connection forming method, a static NAT forming device and a reverse proxy server used in the virtual private network system and virtual private connection forming method, and a virtual connection control device enabling to solve problems of a conventional virtual private network (referred to as “VPN” hereinafter) and achieve strong security and flexible operability by adding extremely light software and hardware.

### BACKGROUND ART

Today, IP network, which originates from the Internet, becomes an indispensable presence for our life and business activities. A company has a LAN configured in its premises, and a server, such as a file server or the like, which includes confidential information and the like is connected to the LAN. The staffs of the company use the information resource provided by the server to carry out their work by using terminals, such as personal computers and/or the like, connected to the LAN. In order to protect the server which includes confidential information and/or the like, a company LAN is typically provided with a firewall at the connecting point between the LAN and the Internet. In such a manner, the LAN is configured so that a malicious third party can not easily break into the LAN of the company from the Internet.

However, when a staff of the company wants to carry out his (or her) work from an outside location by connecting a terminal, such as a personal computer or the like, to the LAN of the company, the firewall will become an obstacle. VPN is used as a technique for the terminal to pass through the firewall and safely connect to the LAN of the company from the Internet.

The VPN is classified into various types by topology; however the VPN can be broadly classified into two types.

One is a method of assigning an IP address belonging to a subnet of the LAN to a terminal existing outside the LAN.

The other is a method called “port forwarding” or “static NAT (Network Address Translation)”.
[Patent document 1] Japanese Unexamined Patent Application Publication No, 2009-272771
[Non-patent document 1] “The ABC of PacketiX—VPNCharacteristics of PacketiX VPN” published by SoftEther Corporation, at the Internet address: http://www.softether.co.jp/jp/vpn2/introduction/about vpn.aspx, searched on Mar. 25, 2010
[Non-patent document 2] “Feature: guide for mastering broadband router” published by ITmedia Ltd., at the Internet address: http://www.atmarkit.co.jp/fpc/special/bbrouter_desc/portforward_dmz.html, searched on Mar. 25, 2010
[Non-patent document 3] “Managing server with ssh passing through the Internet” published by ITmedia Ltd., at the Internet address: http://www.atmarkit.co.jp/fnetwork/rensai/tcp27/01.html, searched on Mar. 25, 2010

### DISCLOSURE OF THE INVENTION

### Problems to be Solved by the Invention

First, the method of assigning an IP address belonging to a subnet of the LAN to a terminal existing outside the LAN will be described below. Such method is disclosed in Non-patent document 1.

Most company LANs use IPv4 private address. Thus, the private address belonging to the subnet of the company LAN is also assigned to a terminal out of the LAN, i.e., a terminal connected to the Internet. However, a global IP address has already been assigned by an Internet service provider (referred to as “ISP” hereinafter) to a network interface card (referred to as “NIC” hereinafter) provided to the terminal. To solve such problem, a virtual NIC is achieved by software, and the IP address belonging to the subnet of the company LAN is assigned to the virtual NIC. The communication with respect to the virtual NIC is encrypted and passed through the firewall.

The problem with such method is that, although the terminal belongs to the subnet of the LAN, it is directly connected to the Internet without being protected by the firewall. In other words, there is a serious problem in security. The terminal is exposed to the threat of the computer virus, the computer worm, the denial-of-service attack (called “DoS”) and the like. Further, there is a high possibility that the information might be leaked.

Further, in the case where the IP address assigned by the ISP is a private address, there is a possibility that the IP address assigned by the ISP and the IP address assigned by the VPN may collide with each other. Even now, the private addresses are assigned to the terminals in public Internet connection points such as the ISP of cable TV affiliates, net cafés and the like. Furthermore, it is predicted that, when carrier-grade NAT, whose diffusion is expected in association with the exhaustion of the address of IPv4, is widely performed in the future (refer to http://itpro.nikkeibp.co.jp/article/COLUMN/20080625/309452/), there will be dramatically increasing possibility that the IP addresses may collide with each other.

Next, the method called “port forwarding” or “static NAT” will be described below. Such method is disclosed in Non-patent document 2 and Non-patent document 3.

For example, a private network of 192.168.0.0/24 is configured in a certain family. In the case where a web server is configured in the family LAN and the web server is to be published on the Internet through a broadband router, a setting called “port forwarding setting” or “static NAT setting” for diverting the packet of a particular port number to a particular machine (server) is done for the broadband router.

For example, a default gateway “192.168.10.1”, as an IP address of the family LAN, is assigned to the broadband router, and the dynamic global IP address assigned by the ISP is “203.178.83.194”. The broadband router is set so that the packet coming from the port 80 of “203.178.83.194” is transferred to the port 80 of another machine provided in the family LAN and having an IP address “192.168.10.2” assigned thereto. The broadband router rewrites the recipient's IP address of the packet from “203.178.83.194” into “192.168.10.2”, and transfers the packet to the server. In such manner, it becomes possible for the server inside the LAN to provide service to the outside (i.e., the Internet) as a web server. Such method is disclosed in Non-patent document 2. Incidentally, the item possible to be rewritten with respect to the packet is not limited to the IP address, but includes the port number.

In many cases, such technique (which is so-called “static. NAT”) is installed as the kernel function (driver) of a POSIX-compliant OS, such as Linux (trademark).

Since the only thing done by the broadband router is diverting the packet from the Internet within the LAN, there is a problem in security. The method for improving security by encrypting and authenticating communication path is an application of OpenSSH (refer to http://www.openssh.com/ja/), which is a kind of SSH (Secure SHell). Such method is disclosed in Non-patent document 3.

However, with the OpenSSH, it is not only necessary to bother to generate a public key for each user who wants to connect to the server and distribute the public key to the user, but also necessary to install an SSH client and the public key on the terminal, which is a client. Further, with the technique like the OpenSSH, the potential risk in security can not be ruled out. In other words, the risk in security depends on the level of the security vulnerability of the OpenSSH. Further, since the default value of sshd (which is the server of the OpenSSH) is set so that the port 22 is open, there is a risk that the port 22 may be susceptible to DoS attack. Furthermore, since the OpenSSH does not do anything in association with security of the terminal (i.e., the client) itself, it is necessary to separately take measures to cope with the security problem of the terminal.

The VPN methods described above are each established to exclusively serve the purpose of “connecting to the server inside the LAN from the Internet”. Further, since it is necessary to bother to set many items and since the possibility of connect failure and the like can not be ruled out, connecting technique of the aforesaid VPN methods is not perfect. Further, it is necessary to separately take measures to cope with the security problem.

In view of the aforesaid technical background, the inventors of the present invention have invented a new network system, a new static NAT forming device and a new reverse proxy device which enable to solve the problems of the conventional VPN and achieve strong security and flexible operability by adding extremely light software and hardware, and filed the patent application (Patent application No. 2010-89873, referred to as “Patent application 1” hereinafter).

In Patent application 1, in order to pass through the single firewall, which hinders the IP reachability, so as to connect the terminal with the server, a static NAT forming device and a reverse proxy server are provided between the terminal and the server, and a virtual connection between the terminal and the server is achieved through an IP address translating process of two stages under the control of the reverse proxy server, wherein the two stages are a port forwarding (static NAT) stage and a reverse proxy stage.

However, the Internet, which is present in the market, does not have the aforesaid simple configuration. There are a plurality of factors that inhibit the IP reachability until reaching the server to be connected, and there are network configuration(s) which can not be connected without passing through a few gateways.

For example, company A and company B have merged with each other. Due to the merger, a gateway server for achieving interconnection is considered to be provided between the LAN of company A and the LAN of company B. However, in order to achieve interconnection between company A and company B, the security policy of the LAN of company A and the security policy of the LAN of company B will be affected, and therefore easygoing connection is discouraged. Further, since the LAN of company A and the LAN of company B are not configured based on a premise that the two companies will merge with each other, there is a possibility that the private IP addresses used in both LANs might duplicate each other. If the subnets and/or the IP addresses duplicate somewhere in the path, it is usually not possible to create an IP reachable (i.e., IP packet reachable) environment.

Therefore, the present invention has been made in view of the above problems, and it is an object of the present invention to provide a new network system, a new virtual private connection forming method, a new static NAT forming device, a new reverse proxy server and a new virtual connection control device capable of connecting even to a server existing in IP not reachable environment by adding extremely light software and hardware.

### Means for Solving the Problems

To solve the aforesaid problems, a network system according to an aspect of the present invention comprises: a first network; a terminal; an application start control section arranged in the terminal and adapted to perform control so that an application program of the terminal accesses a virtual IP address; a static NAT forming device arranged either in the terminal or between the terminal and the first network, and adapted to perform static NAT with respect to an access request made by the application program for accessing the virtual IP address; a second network not IP reachable from the terminal; a server arranged in the second network; one or more reverse proxy server(s) arranged between the static NAT forming device and the server, each reverse proxy server being adapted to either operate a corresponding reverse proxy to transfer a packet transferred from the application program through the static NAT forming device to the server in the case where the reverse proxy server is IP reachable from the server, or transfer the packet transferred from the application program through the static NAT forming device to other IP reachable device by static NAT in the case where the reverse proxy server is not IP reachable from the server; and a virtual connection control device adapted to perform communication with the application start control section and the static NAT forming device, and provide the path information formed by the one or more reverse proxy server(s) to the static NAT forming device.

After the static NAT forming device has performed the authentication through the control session, if the terminal makes a connection request to the server in a private network existing before the reverse proxy server, the static NAT forming device will set a static NAT, and the reverse proxy server will set a reverse proxy, so that a data session will be formed between the terminal and the server. By configuring a network system in such a manner, it is possible to pass through the firewall to achieve a connection from a terminal to a server in a virtual connection state without causing private address collision.

### Advantages of the Invention

With the present invention, it is possible to provide a new network system, a new virtual private connection forming method, a new static NAT forming device, a new reverse proxy server and a new virtual connection control device enabling to achieve strong security and flexible operability by adding extremely light software and hardware.

### BRIEF DESCRIPTION OF DRAWINGS

FIG. 1 is a schematic view showing a network system according to an embodiment of the present invention;

FIG. 2 is a schematic view showing the network system when focusing on a first terminal;

FIG. 3 is a schematic view showing the network system when focusing on a second terminal;

FIG. 4 is a perspective view showing the external appearance of a local master box;

FIG. 5 is a block diagram showing the hardware configuration of the local master box;

FIG. 6 is a functional block diagram of the local master box;

FIG. 7 is a functional block diagram of a soft local master 113;

FIG. 8 is a functional block diagram of a RTA;

FIG. 9 is a functional block diagram of a stepping node;

FIG. 10 is a functional block diagram of another stepping node;

FIG. 11 is a functional block diagram of a conductor;

FIG. 12 is a view showing the configuration of tables included in the conductor;

FIG. 13 is a timing diagram for explaining the flow of the whole operation of the network system of the aforesaid embodiment;

FIG. 14 is a timing diagram for explaining a machine identification ID authentication sequence;

FIG. 15 is a timing diagram for explaining a user authentication sequence and a menu acquiring sequence;

FIG. 16 is a timing diagram for explaining the menu acquiring sequence;

FIG. 17 is a timing diagram for explaining a VPC establishment sequence;

FIG. 18 is a timing diagram for explaining the VPC establishment sequence and a VPC data transfer state;

FIG. 19 is a view schematically showing a packet flowing in the VPC establishment sequence and a VPC establishment request command;

FIG. 20 is a timing diagram for explaining a VPC cutting sequence in the case where the protocol of the communication passing through a VPC tunnel is a connection type communication protocol; and

FIG. 21 is a timing diagram for explaining a user logout sequence and local master shutdown.

### BEST MODES FOR CARRYING OUT THE INVENTION

### Summary of Embodiment

Summary of an embodiment of the present invention will be described below.

The present invention relates to an art developed based on the art disclosed in the Patent Application 1. A network system to be described below is adapted to provide a mechanism for achieving a remote office service over a wide-area private network system of a big company. A staff of the company operates his (or her) terminal in the company from a remote office, a business site where the staff temporarily works or the like, and thereby the desktop environment of his (or her) terminal in a department to which he (or she) is assigned is achieved by the terminal in the business site where the staff temporarily works. The server that provides the remote desktop environment exists in a server of a subnet that is not directly IP reachable from the business site where the staff temporarily works. The network system of the present embodiment achieves a virtual private connection (referred to as “VPC” hereinafter) with respect to the resource of a server not directly IP reachable by using a local master and stepping nodes (which are to be described later).

Incidentally, the remote desktop in the present embodiment means, but obviously is not limited to, an embodiment called Remote Desktop Protocol (RDP) installed on a Windows (trademark). The remote desktop in the present embodiment may also be Virtual Network Computing (VNC), X Window System or the like.

The VPC forms an IP reachable path (tunnel) between a terminal not directly IP reachable and a server. The path formed by the VPC will be referred to as “VPC tunnel” hereinafter. In the VPC tunnel, two IP reachable machines (i.e., the terminal and a local master, the local master and a stepping node, two stepping nodes, and a stepping node and the server) are connected with each other by a “data session”, a static NAT is set for the local master and each stepping node, and a reverse proxy is caused to operate for the stepping node closest to the server.

To achieve the VPC, four new devices and programs described below are provided. The four devices and programs to be described below are uniquely named by the inventors and the applicant of the present invention, because no device providing equivalent functions of these devices and programs has been disclosed in conventional network techniques. In order to form the data session, the devices and programs each form a “control session”, which is a communication channel for performing mutual control.

Stepping Node

The stepping node (also referred to as “reverse proxy server”) is provided at various places of the network, and is adapted to perform two operations.

One operation is to form a data session by the static NAT between the stepping node and the local master (which is to be described later) or between the stepping node and another stepping node so as to form a virtual IP reachable state.

The other operation is to activate reverse proxy to form a data session between the local master (which is to be described later) or another stepping node and an IP reachable server, so as to form a virtual IP reachable state between the terminal and the server.

It seems that the stepping node is a gateway operated by the reverse proxy server or the static NAT, but the process of the reverse proxy is activated or the static NAT is set only when there is a connection request coming from the terminal. Particularly, when the process of the reverse proxy is activated, the stepping node performs, together with the conductor (which is to be described later), authentication.

Thus, unlike a normal server, since the stepping node does not open unnecessarily, it has advantage in security

Local Master

The local master (also referred to as “static NAT forming device”) includes a machine identification ID which shows that the local master is entitled to be connected to the stepping node, and is adapted to perform machine authentication (individual authentication) with the conductor (which is to be described later).

Upon completing the machine authentication, the local master forms a control session (which is a communication channel for control) between the terminal and the conductor. A player (which is to be described later) installed on the terminal uses the control session to perform communication of control information with the conductor. Next, when the player sends a request to the conductor for restriction setting information, which is information about server possible to be reached by the user and information for performing various controls with respect to the terminal, the player acquires these information received from the conductor at he same time, and prepares to form a data session for the terminal to VPC-connect to remote server.

Further, according to necessity, the player also sets packet filter for ensuring security based on the restriction setting information.

The data session is formed by the static NAT (port forwarding).

The packet filter is set so that the operation of the terminal is limited to connecting to the serve only, so that accident factors, such as unintentional connection to an arbitrary server in the Internet, are eliminated. The range of the IP addresses to/from which transmission is prohibited (or permitted) to be transmitted/received is listed in the restriction setting information transmitted from the conductor, and the packet filter is set according to the restriction setting information.

As a packet with respect to the NIC located on the local side of the terminal, the packet between the local master and the server that transmits/receives transmission through the stepping node (which is the reverse proxy) has its address and, according to necessity, port number indicating the other side rewritten by the static NAT. The terminal can communicate with the server in the LAN in a state as if it is communicating with a local NIC.

There are two forms of local masters: one is configured as hardware connected to the terminal (referred to as “local master box” hereinafter), and the other is configured as software installed on the terminal (referred to as “soft local master” hereinafter). The two forms of local masters provide the same functions. The difference between the two forms of local masters is: in the local master box, the static NAT is set in a built-in NIC on the local side, while in the soft local master, the static NAT is set in a built-in loopback virtual NIC, as standard of network OS.

The local master is a device and program whose functions are further organized and improved based on the technique disclosed in Patent document 1, which is a patent application filed in the past by the inventors of the present invention.

Hereinafter, if only “local master” is expressed, it is defined to mean both the local master box and the soft local master. Further, if “the encryption communication processing section of the local master” is expressed hereinafter, it means the functional block common to both the local master box and the soft local master.

Player

In a state where the terminal is connected to the Internet, and further, when the terminal is connected to the server in the LAN through the stepping node, various concerns in security will be raised. In order to strongly restrict the operation of the terminal, the player is installed on the terminal.

The player (also referred to as “behavior restricting section”) performs communication with the local master to provide a user interface for personal authentication, and, when communication between the local master and the stepping node has been established, hooks several application program interfaces (referred to as “API” hereinafter) of the OS.

Application programs and the like prohibited (or permitted) to be performed, and files and the like prohibited to be read, edited, moved and/or erased are listed in the restriction setting information transmitted from the stepping node and acquired through the local master. According to the restriction setting information, the player monitors the hooked API, and strongly restricts the behavior of the terminal.

Further, the player provides the function of personal authentication. The player displays a known login screen on the terminal, acquires the personal authentication information of the user through an authenticating means, such as a keyboard, an IC card reader, a fingerprint authentication machine or the like, and transmits the personal authentication information to the conductor through the control session. If the personal authentication is successful, the player makes a request to the conductor for acquiring restriction setting information, which includes information about the server to be reached by the user and information for performing various controls with respect to the terminal.

Further, the player provides a function as a shell. When the personal authentication is normally completed, the player makes a request to the conductor for acquiring restriction setting information, which includes information about the server to be reached by the user and information for performing various controls with respect to the terminal. When the user has receive the information about the server possible to be reached by the user, the player displays a window on the screen of the terminal, and icon(s) is shown in the window. The icon(s) includes an application start parameter (a command line), and the application name of the application permitted to be performed or the server name of the server permitted to be accessed is designated as the argument of the application. Since the applications are started as child processes of the player, it is possible for the player to easily grasp the behavior of the applications.

An API hooking technique such as virus checker, malware or the like is applied to the player. Since the player operates under the control of the stepping node, if abnormal behavior is detected by the hooked API, it is possible to instantly stop execution and report such fact to the stepping node. Since even unknown virus can be detected by using such technique, it is possible to cope with “zero-day attack” (i.e., prior to the time when a security hole of a program is published and a patch for fixing the security hole of a program is released, attacks exploiting the security hole by a malicious third party is actually performed, and/or a malicious program(s) that exploits the security hole appears), which is a problem recently. Further, even if virus is introduced into the terminal by error, when the player is started to be connected with stepping node, suspicious behavior will be found out instantly based on the result of the API hooking, and therefore it is possible to instantaneously take emergency measures, such as letting the stepping node to force-disconnect the terminal and/or the like.

Conductor

When the terminal is connected to the server by VPC, a plurality of stepping nodes are passed through. In order to establish a connection between the terminal and the server by VPC (i.e., in order for the terminal to get reach to the server), suitable stepping nodes have to be passed through. The conductor provides the path information for forming the VPC tunnel to the local master. In the network system of the present embodiment, the conductor plays the role of a “commander” who provides control information to the stepping nodes for forming the VPC tunnel.

Further, as described above, the conductor performs machine authentication with respect to the local master, and performs personal authentication with respect to the user who operates the terminal. Further, with respect to the terminal having completed the machine authentication and personal authentication, the conductor provides information of the server permitted to be reached by the user.

As describe above, with the four devices and programs, it is possible for the terminal existing in the network to connect to a server desired to be connected by the user through the static NAT of both the local master and the stepping nodes in the path and the reverse proxy of the stepping node closest to the server. At this time, the behavior of the terminal is limited by the player to only perform communication with the server, and other behaviors are significantly restricted.

In such connection state, in both the static NAT and the reverse proxy, the IP addresses assigned to the packet are rewritten a number of times. As a result, unlike the state disclosed in Non-patent document 1 where the terminal is provided with an IP address inside the LAN, the terminal is in a state close to the static NAT connection state disclosed in Non-patent document 3.

[Entire Configuration]

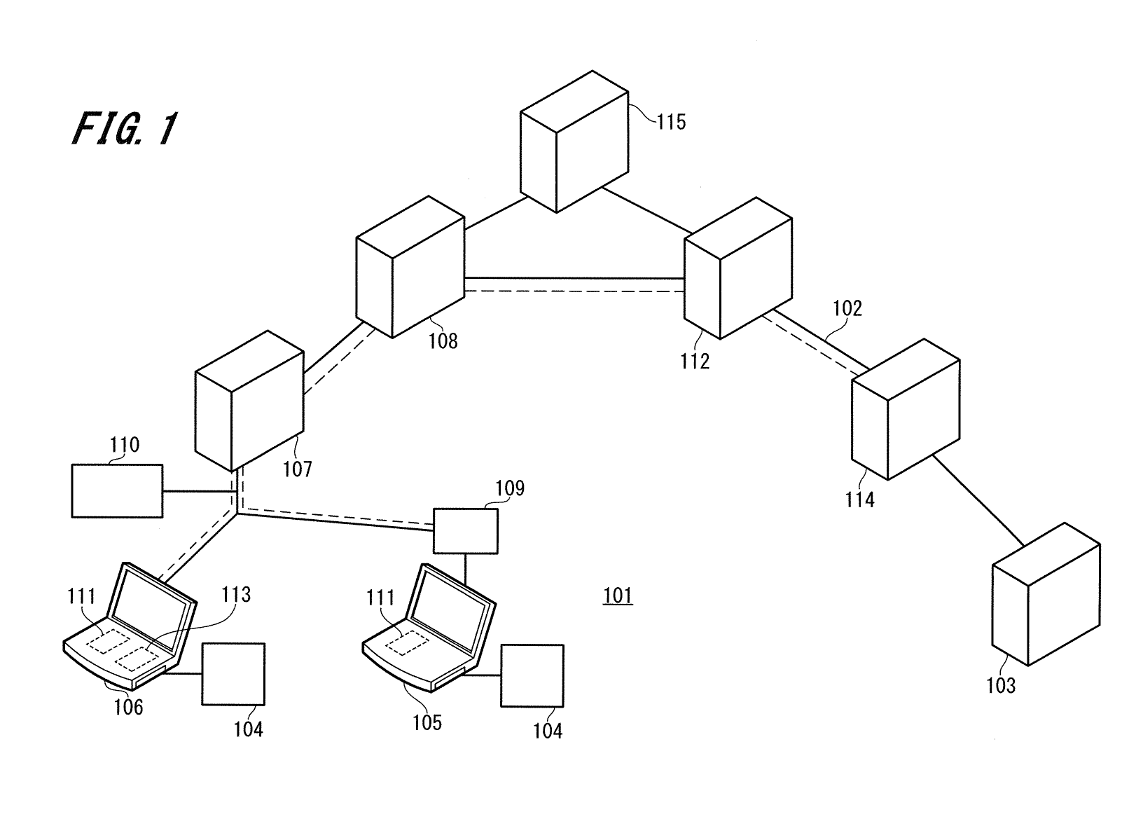

FIG. 1 is a schematic view showing a network system according to an embodiment of the present invention.

A certain company has a larger number of staffs, therefore, for security reasons, a LAN 102 of the company is configured so that it can not be easily accessed passing through a subnet. In such LAN 102, it is tried to achieve a configuration in which a remote desktop environment is introduced, so that wherever a staff is moved to within the company, he (or her) can use a terminal in the destination to achieve the identical desktop environment.

In order to achieve a remote desktop environment with minimal additional investment without changing the security policy of the existing LAN 102, the inventors of the present invention has established an environment in which stepping nodes are provided at various places of the LAN 102, and the terminal is adapted to connect to the target server by tracing the IP reachable stepping nodes from the nearest IP reachable stepping node.

FIG. 1 shows two terminals, which are a first terminal 105 and a second terminal 106. FIG. 1 shows that both the first terminal 105 and the second terminal 106 can be equally connected to a server 103.

The first terminal 105 and second terminal 106 are each a notebook computer or a small personal computer, and are each have a known Linux (trademark) installed thereon as its OS. Incidentally, the OS is a general multitask network OS. The OS may also be a Windows (trademark) or the like, for example, instead of being limited to a Linux (trademark). The terminal constitutes a known thin client (note: a thin client is a small terminal that only provides minimal functions such as screen display, operation input and the like; and in a thin client, many application programs are executed by the server, so that hardware resource can be decreased to the minimum).

An IC card reader 104 for performing personal authentication is connected to each of the first terminal 105 and the second terminal 106.

When the first terminal 105 and the second terminal 106 are to be connected to the LAN 102, a local master needs to be employed.

A local master box 109, which is a local master configured by hardware, is connected to the first terminal 105. The local master box 109 is arranged between the LAN 102 and the first terminal 105.

A soft local master 113, which is a local master configured by software, is installed on the second terminal 106. By installing the soft local master 113 on the second terminal 106 and operating the soft local master 113, the second terminal 106 is connected to the LAN 102 through the soft local master 113.

The local master box 109 or the soft local master 113 connects the network connection formed by the program operated by the first terminal 105 or the second terminal 106 to a first SN 107, which is the nearest first stepping node, via a static NAT.

In other words, instead of being directly connected to the IP address of the first SN 107, the application of the first terminal 105 is connected to a virtual IP address provided by the local master box 109. As a result, the local master box 109 rewrites the IP header of the packet coming from the application of the first terminal 105 via the static NAT. To be specific, the sender's IP address is rewritten from the IP address of the first terminal 105 into the IP address of the local master box 109, and the destination IP address is rewritten from the IP address of the local master box 109 into the IP address of the first SN 107.

The first SN 107 is connected to the local master box 109 and the soft local master 113. The first SN 107 connects the network connection formed by the local master box 109 or the network connection formed by the soft local master 113 to a second SN, which is the nearest IP reachable second stepping node, via a static NAT.

The first SN 107 rewrites the IP header of the packet coming from the local master box 109 or the soft local master 113 via the static NAT. To be specific, the sender's IP address is rewritten from the IP address of the local master box 109 or the IP address of the soft local master 113 into the IP address of the first SN 107, and the destination IP address is rewritten from the IP address of the first SN 107 into the IP address of the second SN.

The second SN 108 is connected to the first SN 107. The second SN 108 connects the network connection formed by the first SN 107 to a third SN 112, which is the nearest third stepping node, via a static NAT.

The second SN 108 rewrites the IP header of the packet coming from the first SN 107 via the static NAT. To be specific, the sender's IP address is rewritten from the IP address of the first SN 107 into the IP address of the second SN 108, and the destination IP address is rewritten from the second SN 108 into the IP address of the third SN 112.

The third SN 112 is connected to the second SN 108. The third SN 112 connects the network connection formed by the second SN 108 to a fourth SN 114, which is the nearest fourth stepping node, via a static NAT.

The third SN 112 rewrites the IP header of the packet coming from the second SN 108 via the static NAT. To be specific, the sender's IP address is rewritten from the IP address of the second SN 108 into the IP address of the third SN 112, and the destination IP address is rewritten from the third SN 112 into the IP address of the fourth SN 114.

The fourth SN 114 is connected to the third SN 112. The fourth SN 114 connects the network connection formed by the third SN 112 to the nearest server 103 via a reverse proxy.

The fourth SN 114 rewrites the IP header of the packet coming from the third SN 112 via the reverse proxy. To be specific, the sender's IP address is rewritten from the IP address of the third SN 112 into the IP address of the fourth SN 114, and the destination IP address is rewritten from the fourth SN 114 into the IP address of the server 103.

The connection state achieved by connecting the terminal to the server 103 through the local master, the first SN 107, the second SN 108, the third SN 112 and the fourth SN 114 via the static NATs and the reverse proxy is referred to as a “VPC”. As shown by the dotted line in FIG. 1, the connection path formed by VPC and configured via the static NATs and the reverse proxy between the terminal and the server 103 is referred to as a “VPC tunnel”.

The character of the VPC tunnel is that the terminals (the first terminal 105 and the second terminal 106) do not know the real IP address of the server 103; and the server 103 does not know the real IP addresses of the terminals connected thereto. The terminal performs communication with the virtual IP address provided by the local master, and the server 103 performs communication with the fourth SN 114. To the terminal, it seems like the virtual IP address provided by the local master is assigned to the server 103; while to the server 103, it seems like the terminal is the fourth SN 114.

Further, a conductor 115 is connected to the second SN 108 and the third SN 112. The conductor 115, which is also referred to as a “virtual connection control device”, performs authentication of both the terminal and the local master, and provides, in response to the request from the local master, the path information for forming the VPC tunnel to the local master.

Although not shown in FIG. 1, there may be more stepping nodes other than the first SN 107, the second SN 108, the third SN 112 and the fourth SN 114 shown in FIG. 1. Under such circumstance, the information of the stepping nodes traced for connecting the terminal to the server 103 in a VPC manner is referred to as “path information”.

The details of the path information will be described later.

The terminal is allowed to be connected to the LAN 102 by providing the local master box 109 or the soft local master 113 in between.

The local master is IP reachable from the first SN 107, but not IP reachable from the second SN 108, the third SN 112, the fourth SN 114 and the server 103. Further, the local master is also not IP reachable from the conductor 115.

As shown in FIG. 1, the subnet connected IP reachable from each other by the first SN 107, the local master box 109 and the second terminal 106 is also referred to as a “first network”.

The first SN 107 is IP reachable from the local master and the second SN 108, but not IP reachable from the terminal, the third SN 112, the fourth SN 114 and the server 103. Further, the first SN 107 is also not IP reachable from the conductor 115.

The second SN 108 is IP reachable from the first SN 107, the third SN 112 and the conductor 115, but not IP reachable from the terminal, the first SN 107, the fourth SN 114 and the server 103.

The third SN 112 is IP reachable from the second SN 108, the fourth SN 114 and the conductor 115, but not IP reachable from the terminal, the first SN 107 and the server 103.

The fourth SN 114 is IP reachable from the third SN 112 and the server 103, but not IP reachable from the terminal, the first SN 107 and the second SN 108. Further, the fourth SN 114 is also not IP reachable from the conductor 115.

As shown in FIG. 1, the subnet connected IP reachable from each other by the fourth SN 114 and the server 103 is also referred to as a “second network”, which is not IP reachable from the first network.

As described above, in a network system 101 of the present embodiment, in an environment where the terminal and the server 103 are not IP reachable from each other, IP unreachable machines can be made virtually IP reachable by providing a stepping node at each IP reachable place, and connecting IP reachable machines by setting the stepping node to the static NAT or the reverse proxy.

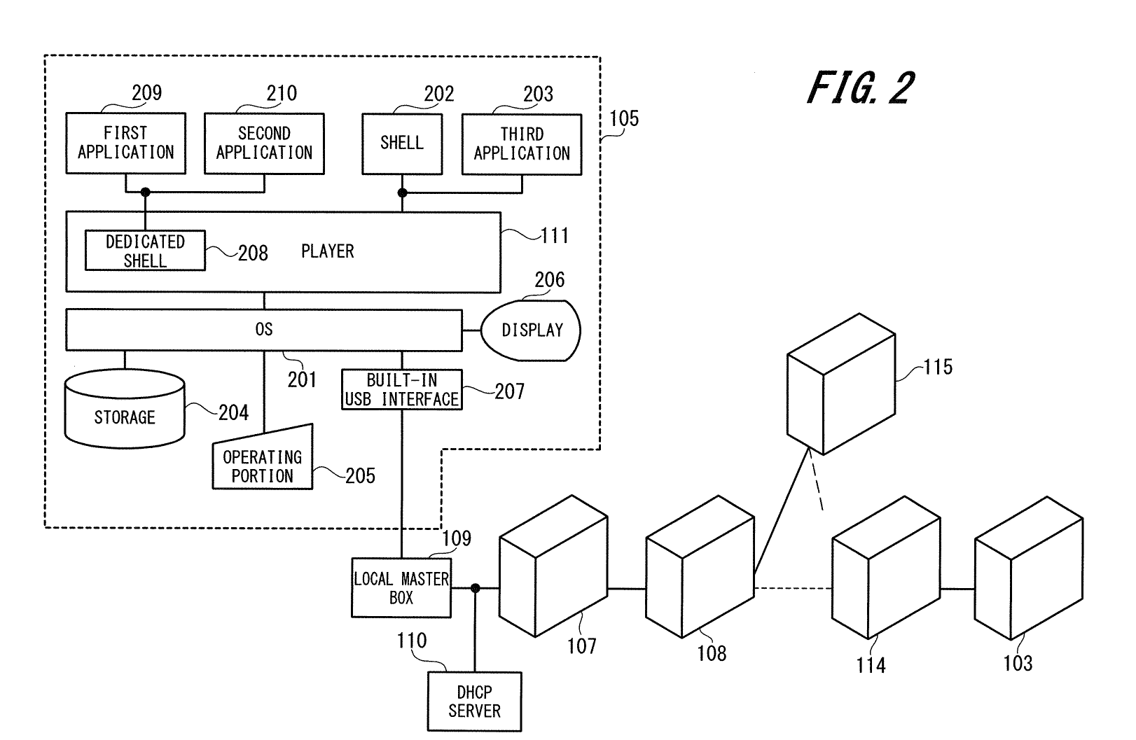

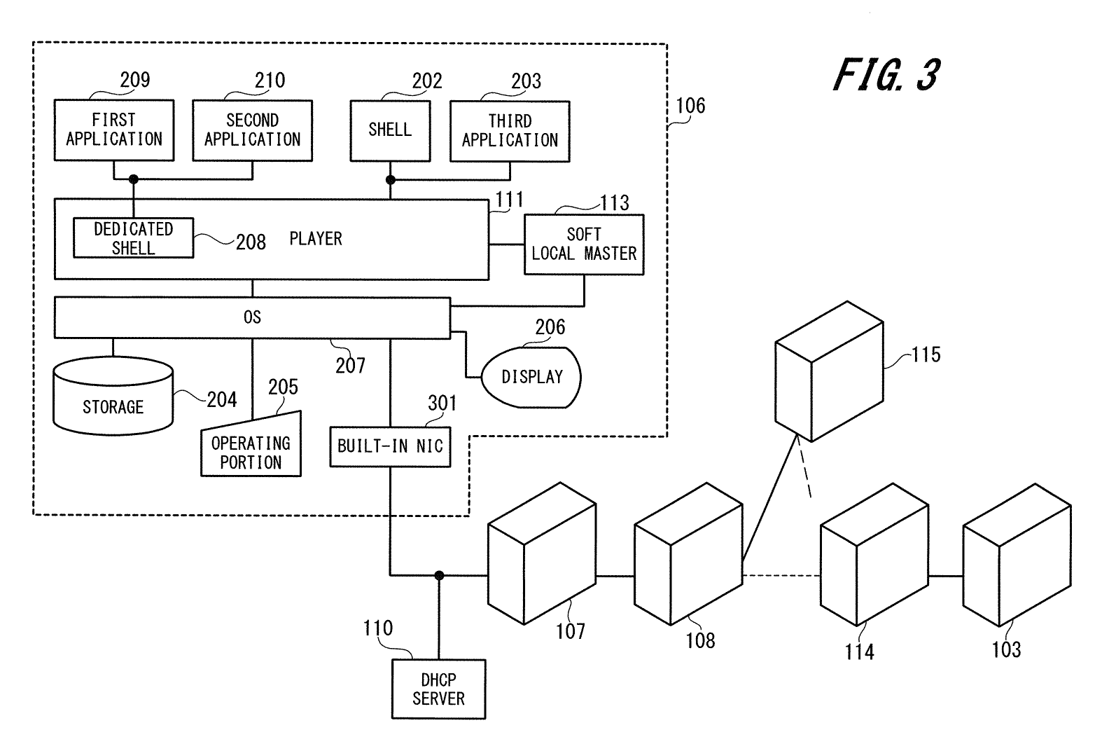

FIG. 2 is a schematic view showing the network system 101 when focusing on the first terminal 105. Due to space limitation of the drawings, the third SN 112 is not indicated in FIG. 2 and FIG. 3.

An OS 201 is installed on the first terminal 105, and application programs, such as a third application 203 and the like, are executed through a shell 202, which is a part of the OS 201. A player 111 is also installed on the first terminal 105, and the player 111 is run by performing a predetermined operation.

The OS 201 controls data input/output to/from the hardware of the first terminal 105, and provides APIs for enabling the applications to easily use the hardware, wherein the hardware includes: a storage 204 such as a hard disk or the like, an operating portion 205 such as a keyboard, a mouse and/or the like, a display 206 such as a LCD or the like, and a built-in USB interface 207.

After completing the personal authentication, the player 111 hooks several APIs of the OS 201 to significantly restrict the behavior of the whole first terminal 105. Further, when abnormality is detected, the player 111 reports the occurrence state and the like of the abnormality to the conductor 115 through the local master box 109, the first SN 107 and the second SN 108.

Further, the player 111 provides a function as a shell, which is also referred to as an “application start control section”. A user interface provided by the player 111 for the user to connect to the server 103 is a dedicated shell 208. When the personal authentication is normally completed, the dedicated shell 208 of the player 111 displays a window on the screen of the first terminal 105, and icon(s) is shown in the window. The icon(s) includes an application start parameter (a command line), and the application name of the application permitted to be executed, the server name of the server 103 permitted to be accessed, the virtual IP address provided by the local master box or the like is designated as the argument of the application. The application programs started as the child processes of the player 111 are a first application 209 and a second application 210 shown in FIG. 2. Since the applications are started as the child processes of the player 111, it is possible for the player 111 to easily grasp the behavior of the applications.

The first application 209 and the second application 210 started from the dedicated shell 208 are shown in FIG. 2. On the other hand, the shell 202 of the OS 201 and the third application 203, which has already been executed until the first terminal 105 had completed the personal authentication, have been started separately. Since the shell 202 of the OS 201 and the third application 203 are not the applications started as the child processes of the dedicated shell 208 of the player 111, the behavior thereof is significantly restricted due to the API hooking function of the player 111. Further, the start of the applications prohibited to be executed and the applications with respect to the files whose “open the file” operation is prohibited is prevented by the player 111, so that these applications can not be executed.

The local master box 109 is connected to the built-in USB interface 207 of the first terminal 105. A DHCP client (which is to be described later) is built into the local master box 109, and the local master box 109 is connected to the LAN 102 by a DHCP server 110, so that the local master box 109 can communicate with an IP reachable machine such as the first SN 107.

FIG. 3 is a schematic view showing the network system 101 when focusing on the second terminal 106.

The second terminal 106 differs from the first terminal 105 in that, instead of the local master box 109, the second terminal 106 has the soft local master 113 installed thereon between the OS 201 and the player 111, and that the second terminal 106 is connected to the LAN 102 by a built-in NIC 301. Thus, in the case of the first terminal 105, the DHCP server 110 provides the dynamic IP address to the local master box 109; while in the case of the second terminal 106, the DHCP server 110 directly provides the dynamic IP address to the built-in NIC 301 built into the second terminal 106. Since the soft local master 113 is installed on the second terminal 106, similar to the case of the first terminal 105 and local master box 109, typical inter-process communication mechanisms, such as message passing, shared memory, named pipe and the like, can be used without needing to transmit/receive predetermined control information through the IP network.

[Local Master Box 109]

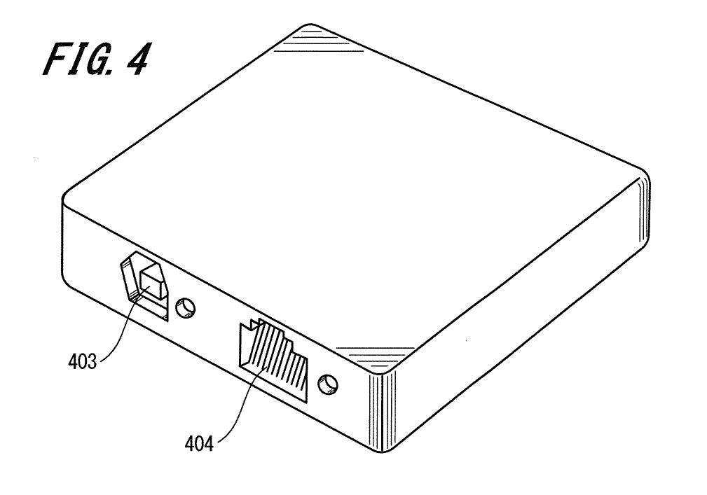

FIG. 4 is a perspective view showing the external appearance of the local master box 109. A USB-B connector 403 and a network connector 404 are provided on the rear face of the local master box 109. The terminal is connected to the USB-B connector 403 through a USB-B cable (not shown in the drawings). A LAN cable is connected to the network connector 404, and the other end of the LAN cable is connected to the DHCP server 110.

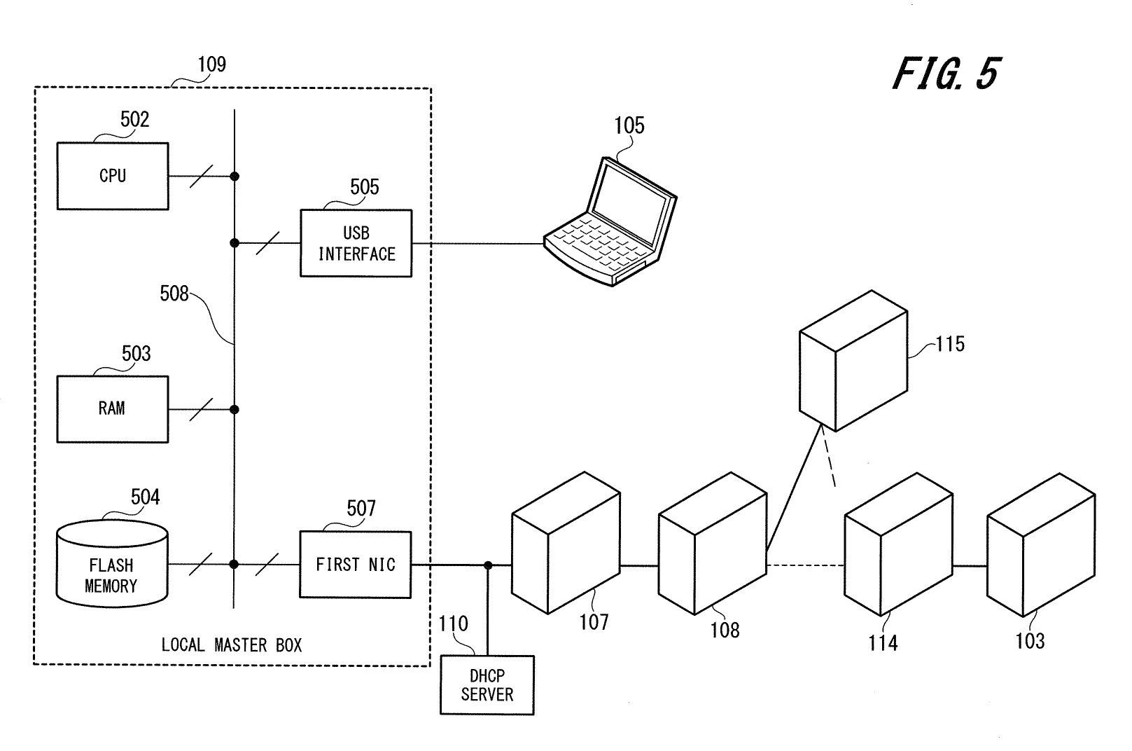

FIG. 5 is a block diagram showing the hardware configuration of the local master box 109.

The local master box 109, which is configured by a microcomputer, includes a CPU 502, a RAM 503, a flash memory 504 (which serves as a nonvolatile storage also used as a ROM), a USB interface 505, a first NIC 507 and a bus 508, wherein the CPU 502, the RAM 503, the flash memory 504, the USB interface 505, the first NIC 507 and the first NIC 507 are connected to the bus 508.

Main parts of the OS 201, such as the kernel, the library, the management command and the like, are stored in the flash memory 504. The OS 201 is, for example, a LINUX (trademark).

The power of the local master box 109 is provided by the first terminal 105 (which is a personal computer) through a USB cable. In other words, the local master box 109 is a bus-powered device.

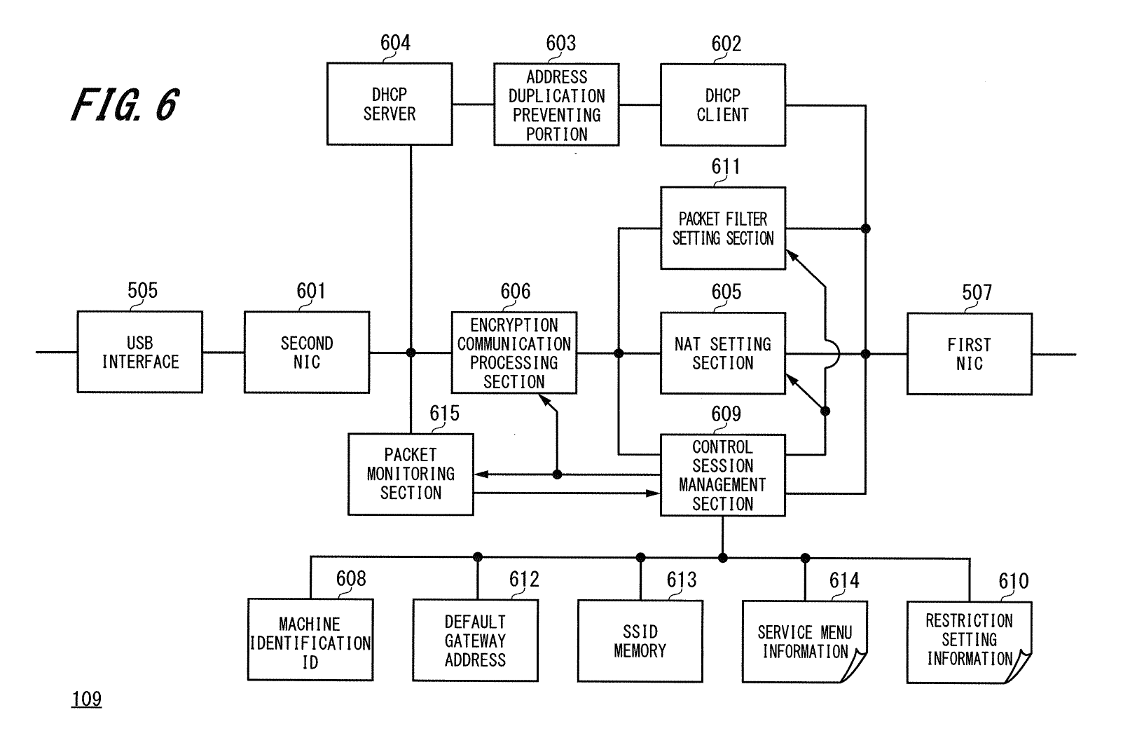

A second NIC 601 (which is not shown in FIG. 5, and is to be described later with reference to FIG. 6) is virtually created by the OS 201 and the application program stored in the flash memory 504.

FIG. 6 is a functional block diagram of the local master box 109.

The local master box 109 has two network interfaces.

The first NIC 507 is a NIC configured as hardware as shown in FIG. 5. The first NIC 507 is connected to the LAN 102, and thereby is IP reachable from the first SN 107.

The second NIC 601 (which is not shown in FIG. 5) is virtually created by the OS 201 and the application program stored in the flash memory 504. When viewed from the first terminal 105, the second NIC 601 is recognized as an external NIC connected to the USB. In other words, the second NIC 601 is a device included in the subnet configured by network system 101 of the first terminal 105, and possible to be accessed directly from the first terminal 105.

When the first NIC 507 of the local master box 109 is connected to the LAN 102, a DHCP client 602 will receive network configuration information from the DHCP server 110 and set the first NIC 507 so that the first NIC 507 is IP reachable from the machine(s) in the LAN 102, wherein the network configuration information includes IP address, netmask, default gateway (in the IP network), name resolver and the like.

Next, an address duplication preventing portion 603 refers to the network configuration information acquired by the DHCP client 602, and adjusts, in the case where the IP address to be assigned to the second NIC 601 belongs to the subnet of the first NIC 507, the start parameter of a DHCP server 604 so that the second NIC 601 belongs to a network of a subnet different from the first NIC 507. To be specific, in the case where the first NIC 507 is assigned with a global IP address, 192.168.0.1 (which is an IP address belonging to a network address 192.168.0.0/24) will be assigned to the second NIC 601 as a default value; however, if the network address of the first NIC 507 is 192.168.0.0/24, then 192.168.1.1 (which is an IP address of 192.168.1.0/24) will be assigned to the second NIC 601.

In a state where the first NIC 507 of the local master box 109 is set by the DHCP server 110 and where a private address is assigned to the second NIC 601 by the DHCP server 604, a NAT setting section 605 configures a general dynamic NAT. By the above configuration, a network connection is formed between the first NIC 507 and the second NIC 601 without problem. Incidentally, at this time, an encryption communication processing section 606 does not perform encryption process and decryption process for a payload portion of the packet flowing between the second NIC 601 and the first NIC 507.

On the other hand, upon knowing that the first NIC 507 has been connected to the network, a control session management section 609 instantly tries to perform machine authentication with the conductor 115. A machine identification ID 608 to be transmitted to the conductor 115 is transmitted to a stepping node described in a default gateway address 612. In the present embodiment, the stepping node is the first SN 107 as shown in FIG. 1.

The machine identification ID 608 to be used to performing machine authentication is encrypted by the encryption communication processing section 606, and transmitted to the conductor 115 through the first SN 107 and the second SN 108. Upon receiving a notification of success of the machine authentication and a session ID (referred to as “SSID” hereinafter) from the conductor 115 through the encryption communication processing section 606, the control session management section stores the SSID in a SSID memory 613.

At this time, a control session is formed among the local master box 109, the first SN 107, the second SN 108 and the conductor 115.

Incidentally, different from a default gateway of a typical IP network, the “default gateway” described in the present embodiment means the IP address or the host name of an IP reachable machine to be traced for being connected to the conductor 115.

The control session is a kind of connection type TCP, and the payload is encrypted by the encryption communication processing section 606. The control session is a protocol uniquely developed by the inventors of the present invention, and is similar to SSL-telnet (a telnet protocol encrypted by SSL). The control session differs from the SSL-telnet in that the control session does not perform screen control. Since only transmission/reception of data is needed to be achieved, the control session does not have a screen control function used in an escape sequence of a VT terminal or the like.

The formation of the control session between the local master and the conductor 115 is similar to that of multiple connections of TELNET. In other words, after the TELNET is logged in to the first SN 107 from the local mister, the TELNET is logged in to the second SN 108 with the first SN 107 as a platform, and further, the TELNET is logged in to the conductor 115 with the second SN 108 as a platform.

When the player 111 of the first terminal 105 starts, it makes a request to the connected local master box 109 through the control session for acquiring a SSID. This operation is repeatedly performed until the local master box 109 returns a SSID. In other words, the player 111 polls a request for acquiring a SSID.

Upon receiving the request for a SSID from the player 111, the control session management section 609 returns a SSID if there is a SSID stored in the SSID memory 613. If it is not such a case, i.e., at the time when the machine authentication performed on the conductor 115 has not been completed and therefore no SSID is received from the conductor 115, the control session management section 609 sends an error to the player 111 as a reply.

Upon receiving the SSID from the local master box 109, the player 111 recognizes that the local master box 109 has succeeded at performing machine authentication. Next, upon storing the received SSID in a RAM (not shown in the drawings), the player 111 displays a login screen on the display 206 of the first terminal 105.

The user performs user personal authentication by using the IC card reader 104, the operating portion 205 of the first terminal 105, or the like. The personal authentication information inputted by the user is transmitted by the player 111 to the local master box 109 through the control session. Incidentally, there are various kinds of personal authentication information. In the case where the authentication is performed by using the operating portion 205, the personal authentication information will be a typical user ID and password. Other methods include a method in which information used in personal authentication obtained from a personal authentication machine, such as a fingerprint authentication machine, an IC card reader 104 or the like, is used. Hereinafter, all these information for authenticating the user who is to use the terminal is collectively referred to as “personal authentication information”.

The personal authentication information is encrypted by the encryption communication processing section 606, which is controlled through the control session management section 609, and transmitted to the conductor 115. The notification of success of personal authentication sent from the conductor 115 as a reply reaches the first terminal 105.

Upon receiving the notification of success of personal authentication coming from the conductor 115, the player 111 makes a request to the conductor 115 for acquiring information about the service possible to be used by the user. In response to the request, the conductor 115 transmits the information about the service possible to be enjoyed by the user and the information for restricting the behavior of the first terminal 105 and the local master box 109.

The information about the service possible to be enjoyed by the user is stored in the player 111, and is also transferred to and stored in the local master box 109 as service menu information 614.

The information for restricting the behavior of the first terminal 105 and the local master box 109 is stored in the player 111, and is also transferred to and stored in the local master box 109 as restriction setting information 610.

The control session management section 609 of the local master box 109 reads out packet filtering setting information described in the restriction setting information 610 received from the conductor 115 to control a packet filter setting section 611. The packet filter setting section 611 configures a packet filter according to the packet filtering setting information provided from the control session management section 609.

Next, based on the stored service menu information 614, the control session management section 609 of the local master box 109 sets a packet monitoring section 615 so that a port number adapted to form the data session is monitored by the packet monitoring section 615.

If a TCP SYN packet comes to the port number adapted to form the data session of the IP address assigned to the second NIC 601, the packet monitoring section 615 will report this truth to the control session management section 609. Upon receiving the report, the control session management section 609 starts communication for forming the data session.

Further, in the case where the data session to be set is a connection type communication, the packet monitoring section 615 will also monitor TCP FIN packet. In the case of a protocol in which the TCP FIN packet is transmitted only triggered by the termination of the client, such as RDP, SSH or the like, the data session can be directly terminated (closed) by detecting the incoming of the TCP FIN packet.

Conversely, in the case where the data session to be set is a connectionless type protocol such as HTTP, the TCP FIN packet will be transmitted every time when a data stream is transmitted. Thus, in the case of a connectionless type protocol, the TCP FIN packet should not be used as a trigger to close the data session. In other words, the VPC tunnel, which passes through HTTP, has to also correctly transfer the TCP FIN packet. In thus case, the terminal expressly notifies through the control session that the data session has terminated.

[Soft Local Master 113]

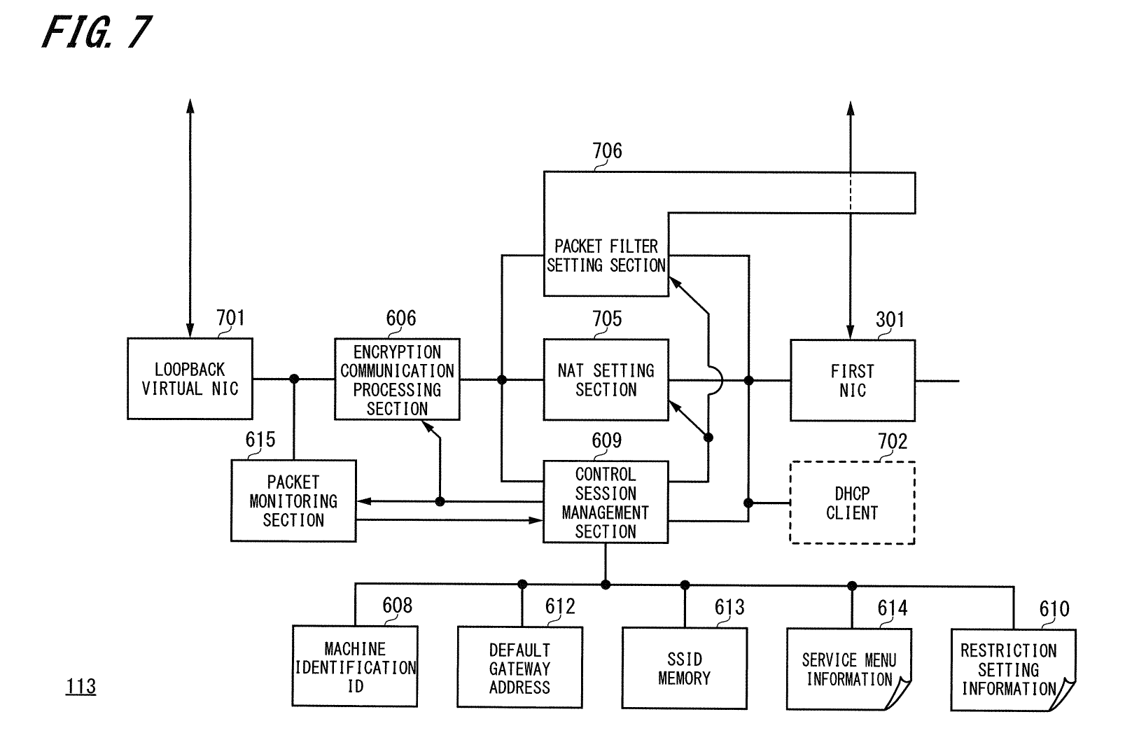

FIG. 7 is a functional block diagram of the soft local master 113.

The soft local master 113 has two network interfaces.

The built-in NIC 301 is a NIC built into the second terminal 106 as hardware, and is connected to the LAN 102.

A loopback virtual NIC 701 a is a known loopback interface provided, as standard, to the network OS 201 of Ipv4 protocol installed on the second terminal 106. Even if the terminal is provided with no NIC, a loopback interface having an IP address 127.0.0.1 assigned thereto is necessarily configured in the OS 201 as long as the OS 201 supports the IPv4 protocol. Unless a particularly setting is performed, the packet transmitted to the loopback interface will be sent to a place of the terminal for receiving packet. In other words, the transmitted packet returns to the starting point (i.e., the terminal itself), just like drawing a loop.

In the case of the local master box 109, the first NIC 507 is not a device possible to be directly accessed by the first terminal 105. However, in the case of the soft local master 113, both the built-in NIC 301 and the loopback virtual NIC 701 are devices possible to be equally accessed from the OS 201 and the applications of the second terminal 106.

When the built-in NIC 301 of the soft local master 113 is connected to the LAN 102, a DHCP client 702 will receive network configuration information from the DHCP server 110 through the built-in NIC 301, and set the built-in NIC 301 so that the built-in NIC 301 can be connected to the network, wherein the network configuration information includes IP address, netmask, default gateway, name resolver and the like.

In the case of the local master box 109, after the above steps, a process for preventing duplication of the subnet of the first NIC 507 and the subnet of the second NIC 601 needs to be performed; however, since the network segment of the loopback virtual NIC 701 and the network segment of the built-in NIC 301, which has a global or private IP address assigned thereto, will never duplicate each other, the address duplication preventing portion 603 is not necessary to be provided. Further, since the loopback address is fixed, the DHCP server 604 is also not necessary to be provided.

A NAT setting section 705 does not do anything in a state where the built-in NIC 301 of the soft local master 113 is connected to the LAN 102. Further, a packet filter setting section 706 does not do anything in such state. With such configuration, the OS 201 and the applications can be connected to the network through the built-in NIC 301 without problem. Incidentally, at this time, the encryption communication processing section 606 does not perform encryption process and decryption process for the packet flowing between the loopback virtual NIC 701 and the built-in NIC 301.

On the other hand, upon knowing that the built-in NIC 301 has been connected to the network, the control session management section 609 instantly tries to perform machine authentication with the conductor 115. The machine identification ID 608 to be transmitted to the conductor 115 is transmitted to a stepping node described in the default gateway address 612. In the present embodiment, the stepping node is the first SN 107 as shown in FIG. 1.

The machine identification ID 608 to be used to perform machine authentication is encrypted by the encryption communication processing section 606, and transmitted to the conductor 115 through the first SN 107 and the second SN 108. Upon receiving a notification of success of the machine authentication and a session ID (referred to as “SSID” hereinafter) from the conductor 115 through the encryption communication processing section 606, the control session management section 609 stores the SSID in the SSID memory 613.

At this time, a control session is formed among the soft local master 113, the first SN 107, the second SN 108 and the conductor 115.

When the player 111 of the first terminal 105 is activated, it makes a request to the connected local master box 109 through the control session for acquiring a SSID. This operation is repeatedly performed until the local master box 109 returns the SSID. In other words, the player 111 polls the request for acquiring a SSID.

Upon receiving the request for a SSID from the player 111, the control session management section 609 returns a SSID if there is a SSID stored in the SSID memory 613. If it is not such a case, i.e., at the time when the machine authentication performed on the conductor 115 has not been completed and therefore no SSID is received from the conductor 115, the control session management section 609 will send an error to the player 111 as a reply.

Upon receiving the SSID from the soft local master 113, the player 111 recognizes that the soft local master 113 has succeeded at performing machine authentication. Next, upon storing the received SSID in a RAM (not shown in the drawings), the player 111 displays a login screen on the display 206 of the first terminal 105.

The user performs personal authentication by using the IC card reader 104, the operating portion 205 of the first terminal 105, or the like. The personal authentication information is transmitted by the player 111 to the local master box 109 through the control session.

The personal authentication information is encrypted by the encryption communication processing section 606, which is controlled through the control session management section 609, and transmitted to the conductor 115. The notification of success of personal authentication returned from the conductor 115 is transferred to the first terminal 105.

Upon receiving the notification of success of personal authentication coming from the conductor 115, the player 111 makes a request to the conductor 115 for acquiring information about the service possible to be used by the user. In response to the request, the conductor 115 transmits the information about the service possible to be enjoyed by the user and the information for restricting the behavior of the first terminal 105 and the local master box 109.

The information about the service possible to be enjoyed by the user is stored in the player 111 as service menu information. The service menu information 614 is also used by the soft local master 113.

The information for restricting the behavior of the first terminal 105 and the local master box 109 is stored in the player 111 as the restriction setting information 610. The restriction setting information 610 is also used by the soft local master 113.

In the case of the local master box 109, when the restriction setting information 610 and the service menu information 614 is transferred to the player 111, these two pieces of information are also acquired by the local master box 109 and stored in the local master box 109; however, in the case of the soft local master 113, since the soft local master 113 and the player 111 coexist in the second terminal 106, the player 111 can instantly refers to the restriction setting information 610 received from the conductor 115. Thus, essentially there will not be a step for the soft local master 113 to transmit the restriction setting information 610 to the player 111.

The control session management section 609 of the soft local master 113 reads out the packet filtering setting information described in the restriction setting information 610 received from the conductor 115 to control the packet filter setting section 706. The packet filter setting section 706 configures a packet filter according to the packet filtering setting information provided from the control session management section 609.

Next, based on the stored service menu information, the control session management section 609 of the soft local master 113 sets the packet monitoring section 615 so that a port number adapted to form the data session is monitored by the packet monitoring section 615.

If a TCP SYN packet comes to the port number adapted to form the data session of the IP address assigned to the second NIC 601, the packet monitoring section 615 will report this truth to the control session management section 609. Upon receiving the report, the control session management section 609 starts communication for forming the data session.

Further, in the case where the data session to be set is a connection type communication, the packet monitoring section 615 will also monitor TCP FIN packet. In the case of a protocol in which the TCP FIN packet is transmitted only by the termination of the client, such as RDP (Remote Desktop Protocol), SSH or the like, the data session can be directly terminated (closed) by detecting the incoming of the TCP FIN packet.

Conversely, in the case where the data session to be set is a connectionless type protocol such as HTTP, the TCP FIN packet will be transmitted every time when a data stream is transmitted. Thus, in the case of a connectionless type protocol, the TCP FIN packet should not be used as a trigger to close the data session. In other words, the VPC tunnel, which passes through HTTP, has to also correctly transfer the TCP FIN packet. In thus case, the terminal expressly notifies through the control session that the data session has terminated.

The local master box 109 and the soft local master 113 have been described above.

As can be known from the above description, the local master adds a restriction, by using a packet filter, on a communication generated from the application operated by the terminal or operated through the OS 201, based on an instruction of the conductor 115 (i.e., the restriction setting information 610 created by the conductor 115). Further, in order for the user to achieve a virtual connection to the permitted server 103, the local master sets a static NAT with respect to the nearest stepping node.

By performing the static NAT, the terminal can be connected to the server 103 through the Internet 107 and the firewall, in the same state as if it is connected to the server 103 in the LAN 102.

[Player 111]

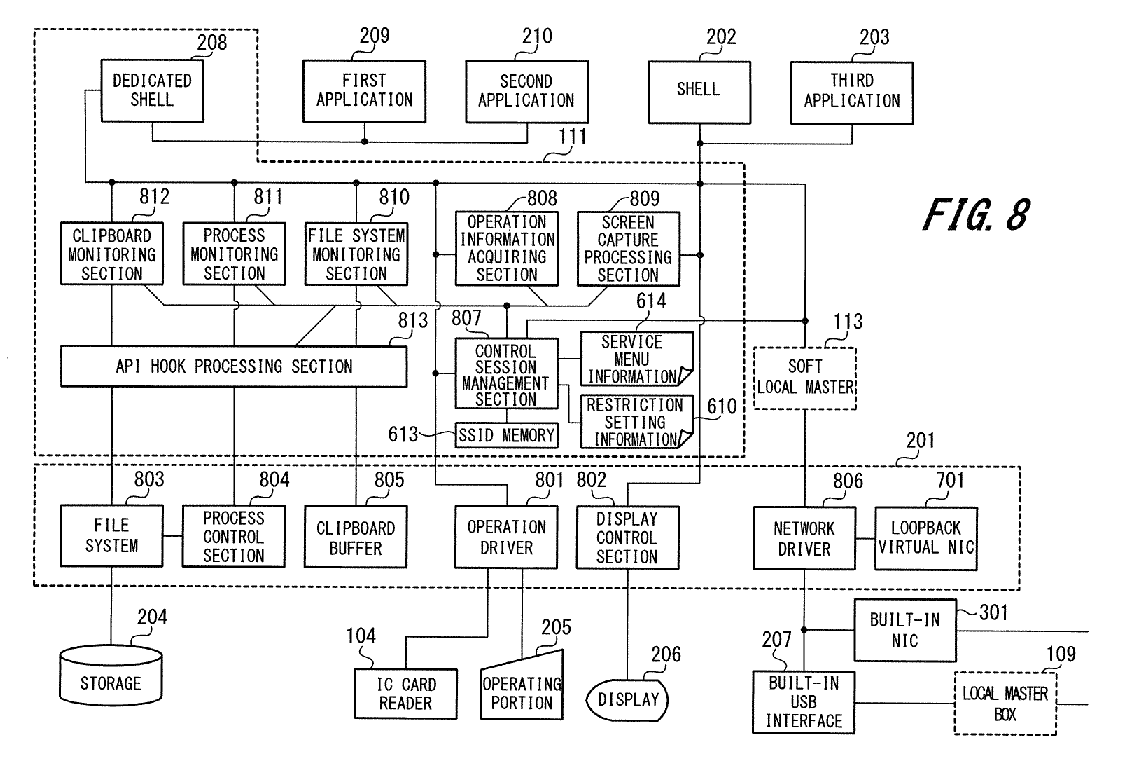

FIG. 8 is a functional block diagram of the player 111. Based on the instruction of the conductor 115 (i.e., the restriction setting information 610 transmitted from the conductor 115), the player 111 monitors both the application started by the terminal and the device used with the operation of the application, performs control to restrict the operation and the like according to necessity, and performs management of log record and the like. In order to achieve such function, the player 111 hooks the API owned by the OS 201 to constantly monitor the behavior of the application and the behavior of the OS 201. If the API satisfies the restriction condition described in the restriction setting information 610, the player 111 will prevent the API from being activated, and report to the conductor 115 through the local master that the API is prevented from being activated.

FIG. 8 also shows the OS 201 and the applications, which are indispensable for describing the player 111, as functional block diagrams.

The OS 201 includes various functions; however, when describing the present embodiment, the OS 201 can be considered as a collection of device drivers for the applications to easily handle the hardware. Further, each device driver is also referred as a collection of API(s). FIG. 8 shows functional blocks mainly focusing on these hardware and device drivers.

Examples of the mains hardware provided in the terminal include the operating portion 205 (which is a pointing device such as a keyboard, a mouse and/or the like), the display 206 such as a LCD or the like, the storage 204 such as a hard disk or the like, and a NIC. However, in the case of the first terminal 105, the NIC is virtually provided as the second NIC 601 in the local master box 109. In any cases, NIC exists as long as the terminal is connected to a network.

An operation driver 801 turns over the operation information coming from the operating portion 205 and the personal authentication information outputted by the IC card reader 104 to the application, the shell 202, a control session management section 807 and the like.

A display control section 802 converts screen drawing instruction information generated from the application, the shell 202 and the like into actual screen drawing information, and turns over the converted information to the display 206.

A file system 803 configures files and directories in the storage 204, and operates the files and directories according to the instruction of the application and the shell 202.

A process control section 804 controls the execution and termination of the application, the library and the like stored in the storage 204 through the application, the shell 202 and the like.

A clipboard buffer 805 functions as a temporary buffer for copying, moving and erasing of data object between any two of the applications and the shell 202.

A network driver 806, which is also referred to as “TCP/IP protocol stack”, creates an environment for enabling the application and the shell 202 to communicate with the network, and controls the communication.

The network driver 806 also includes the DHCP client 702.

In the case where the local master box 109 is used, the DHCP client 602 of the local master box 109 provides the dynamic IP address to the first NIC 507 of the local master box 109 based on the network configuration information received from the DHCP server 110 of the LAN 102. Further, the DHCP client 702, which is one of the functions of the network driver 806, provides the dynamic IP address to the second NIC 601 of the local master box 109 based on the network configuration information received from the DHCP server 604 of the local master box 109.

In the case where the soft local master 113 is used, the DHCP client 702, which is one of the functions of the network driver 806, provides the dynamic IP address to the built-in NIC 301 based on the network configuration information received from the DHCP server 110 of the LAN 102.

When the player 111 is activated by user's operation through an initial booting process of the OS 201 or shell 202, or activated by connecting a USB device with the player 111 stored therein to the terminal so that the player is run automatically, firstly the control session management section 807 makes a request to the local master box 109 or the soft local master 113 for acquiring a SSID.

When the acquisition of the SSID from the local master box 109 or the soft local master 113 is successful, the control session management section 807 next performs the personal authentication. The control session management section 807 transmits the personal authentication information acquired by the IC card reader 104, the operating portion 205 or the like to the conductor 115, and waits for the result of the personal authentication.

Upon receiving a report that the personal authentication has been successful from the conductor 115 through the local master box 109 or the soft local master 113, the control session management section 807 makes a request to the conductor 115 for acquiring the restriction setting information 610 and the service menu information 614.

In the case where the soft local master 113 is used, after the personal authentication has been successful, the player 111 downloads the restriction setting information 610 and the service menu information 614 from the conductor 115, and holds the restriction setting information 610 in a RAM (not shown in the drawings) of the terminal. The held restriction setting information 610 and the service menu information 614 are shared by the soft local master 113.

In the case where the local master box 109 is used, after the personal authentication has been successful, the player 111 downloads the restriction setting information 610 and the service menu information 614 from the conductor 115, and holds the restriction setting information 610 in a RAM (not shown in the drawings) of the terminal; and at this time, since the local master box 109 is configured by the hardware separated from the terminal, the local master box 109 needs to separately acquire the restriction setting information 610 and the service menu information 614. Thus, in the present embodiment, the restriction setting information 610 and the service menu information 614 are acquired by employing a method in which, at the moment immediately before the restriction setting information 610 and the service menu information 614 have been received by the player 111, the restriction setting information 610 and the service menu information 614 are once held by the local master box 109 between the player 111 and the conductor 115, and than transmitted to the player 111. Obviously, instead of being limited to the aforesaid method, another method may also be employed in which the player 111 explicitly transmits the received restriction setting information 610 and the service menu information 614 to the local master box 109.

Upon acquiring the restriction setting information 610 from the conductor 115, the control session management section 807 of the player 111 sets an operation information acquiring section 808, a screen capture processing section 809, a file system monitoring section 810, a process monitoring section 811, a clipboard monitoring section 812 and an API hook processing section 813 according to the restriction setting information 610.

As the behavior with respect to the particular file and directory designed by the restriction setting information 610, the file system monitoring section 810 monitors copying, moving, erasing, and name changing.

The process monitoring section 811 monitors process start and self process hiding conduct of a particular application and the like designed by the restriction setting information 610.

The clipboard monitoring section 812 monitors the copying operation, moving operation, erasing operation and the like of the data object with respect to the clipboard buffer 805 performed by the particular application designed by the restriction setting information 610.

The API hook processing section 813 respectively achieve the API hooking process performed by the file system monitoring section 810 with respect to the file system 803, the API hooking process performed by the process monitoring section 811 with respect to the process control section 804, and the API hooking process performed by the clipboard monitoring section 812 with respect to the clipboard buffer 805. If the shell 202 and the application try to perform any operation on files and processes, the file system monitoring section 810 and the process monitoring section 811 will be called up by the API hook processing section 813 to judge whether or not the corresponding API should be executed.

The operation information acquiring section 808 refers to the information described in the restriction setting information 610; and if the condition described in the information is satisfied, the operation information acquiring section 808 will report the operation information acquired from the operation driver 801 to the conductor 115 through the local master box 109 or the soft local master 113.

The screen capture processing section 809 refers to the information described in the restriction setting information 610; and if the condition described in the information is satisfied, the screen capture processing section 809 will report the bit map screen information acquired from the display control section 802 to the conductor 115 through the local master box 109 or the soft local master 113.

The dedicated shell 208 creates icon(s) according to the description of the restriction setting information 610, where the icon(s) includes the application program name of the application permitted to be executed by the user and the resource (i.e., information resource) name of the server 103 permitted to be accessed by the user. The content of the icon(s) is a command line character string, in which the application program name to be executed and the resource name of the server 103, as the argument of the application program name, are described. Further, various option switches necessary for starting the application program are also included in the command line character string, depending on the application program. The application programs, which are started by clicking the icon with a pointing device such as a mouse, are the first application 209 and the second application 210 shown in FIG. 8. Since the first application 209 and the second application 210 are started as the child processes of the dedicated shell 208, it is possible to completely grasp the behavior of the first application 209 and the second application 210 through the dedicated shell 208.

On the other hand, the OS 201 is provided with the shell 202 as standard. Further, obviously there is application program(s) started from the shell 202. With regard to the shell 202 and the application (note: in FIG. 8, the application here is the third application 203) that do not pass through the dedicated shell 208, the file system monitoring section 810, the process monitoring section 811 and the clipboard monitoring section 812 closely monitor the behavior of the shell 202 and application, and immediately stop the operation possible to become a security threat to the server 103. Further, with regard to the application program prohibited to be started, such application program is force-quitted by the process monitoring section 811.

[Stepping Node]

There are two kinds of stepping nodes, one is a device without firewall, and the other is a device with a firewall. The function of both kinds of stepping nodes will be described below.

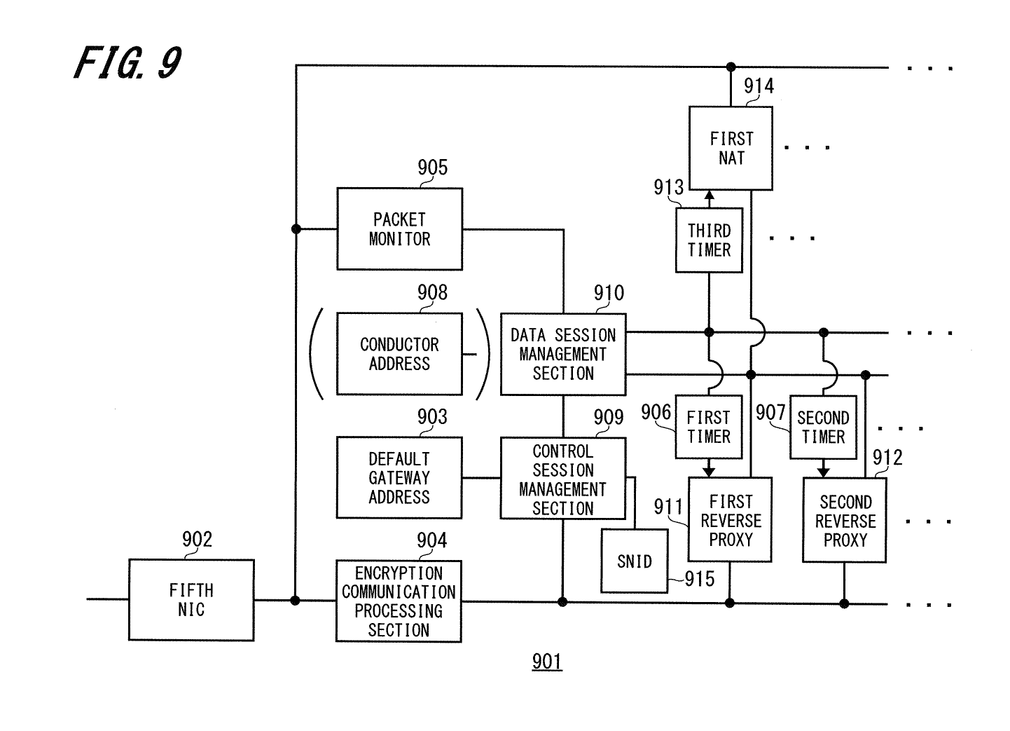

FIG. 9 is a functional block diagram of a stepping node. The stepping node shown in FIG. 9 is a device without a firewall.

A stepping node 901 is a computer operated by a network OS. As an example, it is preferred that a POSIX-compliant OS, such as Linux (trademark), is used as the OS.

The stepping node 901 of the present embodiment is arranged at an important position of the LAN 102, and is specialized as a gateway between two IP directly unreachable stepping nodes, or between the stepping node and the server.

A fixed IP address is assigned to a fifth NIC 902 connected to the LAN 102.

An encryption communication processing section 904 connected to the fifth NIC 902 is paired with the encryption communication processing section 606 provided to the local master box 109 or the soft local master 113. In other words, the encryption communication processing section 904 transmits/receives the authentication information to/from the player 111 and the local master, and encrypts the control session and the data session.

A control session management section 909 is paired with the control session management section 609 provided in the local master box 109 or the soft local master 113, and paired with the control session management section 807 provided in the player 111. In other words, the control session management section 909 forms a control session between the control session management section 909 and the local master, and transmits/receives various control information to/from the local master or the local master or the player 111. Thus, the default gateway address 612 or a conductor address 908 is stored in the control session management section 909.

In response to the connection request sent from the local master to the server 103, a data session management section 910 activates a reverse proxy corresponding to the server 103 or sets a static NAT through the local master box 109 to form a data session between the data session management section 910 and the IP reachable local master, other stepping node, and/or the server 103.

The processes of the reverse proxy started by the data session management section 910 are arranged in the order of: a first reverse proxy 911, a second reverse proxy 912 . . . , as shown in FIG. 9, and the number of the processes of the reverse proxy changes according to the number of the data sessions formed between the stepping node and the terminal.

Similarly, the static NATs set by the data session management section 910 are arranged in the order of: a first NAT 914, a second NAT (not shown in the drawing) . . . , as shown in FIG. 9, and the number of the static NATs changes according to the number of the data sessions formed between the stepping node and the terminal.

The number of the data sessions changes according to the number of the data sessions formed from the terminal, and also changes according to the number of the terminals, or furthermore, according to the number of the users who use the terminals. For example, the HTTP data session of user A and the RDP data session of user A are independent. The HTTP data session of user B and the RDP data session of user B are also independent. These data sessions are completely independently formed. Particularly, in the case of a protocol like SSH, a plurality of data sessions are formed by one user according to the number of SSH servers to be connected to. In these data sessions, if the stepping node is a termination end, a process of reverse proxy will be started; while if the stepping node is not a termination end, setting of static NAT will be performed.

Incidentally, the term “setting of static NAT” is referred to on the basis of a supposition that a static NAT is set by performing setting with respect to the function of the OS of the stepping node. For example, in the case of Linux (trademark), the term “setting of static NAT” means an operation for setting a static NAT by using an iptables utility with respect to a Netfilter driver of the kernel. If the static NAT is also configured by an independent program and is multiply-started according to the number of the data sessions, then the term “setting of static NAT” means “starting a static NAT program”. In other words, the meaning of the term “setting of static NAT” changes according to the method to achieve a static NAT.

The data session management section 910 sets a static NAT in a connection between the local master and other stepping node, or in a connection between two stepping nodes. This is because that it is not necessary to decrypt the encrypted payload portion of the packet, and the only thing needs to do is to rewrite the IP address and the port number described in the IP header portion of the packet.

In contrast, the data session management section 910 sets a reverse proxy in a connection between the local master or other stepping node and the server 103. This is because that, to achieve the communication with the server 103, it is necessary to decrypt the encrypted payload portion of the packet, and further, there is the case where processes need to be performed according to a TCP/IP fourth layer (an application) may be requested. For example, as error handling of HTTP, a function can be considered in which, if there is an error in call method or syntax of URL, instead of the server 103, by returning the “400 Bad Request” returned by the web server, the load of the server 103 can be reduced.

A packet monitor 905 monitors the TCP ACK+SYN packet coming into the data session.

In response to the TCP SYN packet coming from the terminal, the VPC tunnel forms a static NAT or a reverse proxy according to a VPC establishment request command transmitted from the local master; however, in the case where the server 103 fails to response the request of the terminal due to some sort of failure, the set VPC tunnel has to be cancelled. A timer is used to set a time limit for the static NAT or reverse proxy temporarily set according to the VPC establishment request command transmitted from the local master. As shown in FIG. 9, the data session management section 910 also activates a first timer 906 while activating the first reverse proxy 911. Similarly, the data session management section 910 also sets a second timer 907 while activating the second reverse proxy 912, and sets a third timer 913 while setting the first NAT 914.

These timers are used to determine whether or not the temporarily activated reverse proxy or the temporarily set static NAT should be left unchanged.

If there is a TCP ACK+SYN packet coming from the server 103 into the VPC tunnel provided by the reverse proxy or the static NAT, then it will be known that the server 103 is in a state capable of performing communication with the terminal. Thus, the packet monitor 905 monitors the incoming of TCP ACK+SYN packet; if a TCP ACK+SYN packet comes, the packet monitor 905 will stop the time counting operation of the timer that operates in conjunction with the corresponding reverse proxy or static NAT.

If no TCP ACK+SYN packet comes within a predetermined time set by the timer, the packet monitor 905 will stop the corresponding reverse proxy or static NAT after the timer has counted the predetermined time. In other words, the temporarily set VPC tunnel is cancelled due to out of time.

A reverse proxy server program (not shown in the drawings) is prepared according to the type of the protocol used when accessing the server 103. If the protocol is HTTP, then a result code of proxy mode will be provided. If the protocol is CIFS (Common Internet File System: a protocol extended from a file-sharing service protocol (SMB: Server Message Block) of Windows (trademark)) or RDP, then the only operation needs to be performed is to rewrite IP address.

A SNID 915, which is information for uniquely identifying the stepping node, is connected to the control session management section 909. The SNID 915 is information used to set reverse proxy in the steps for forming the VPC tunnel described in the present embodiment, and is important as information for the conductor 115 (which is to be described later) to create the path information.

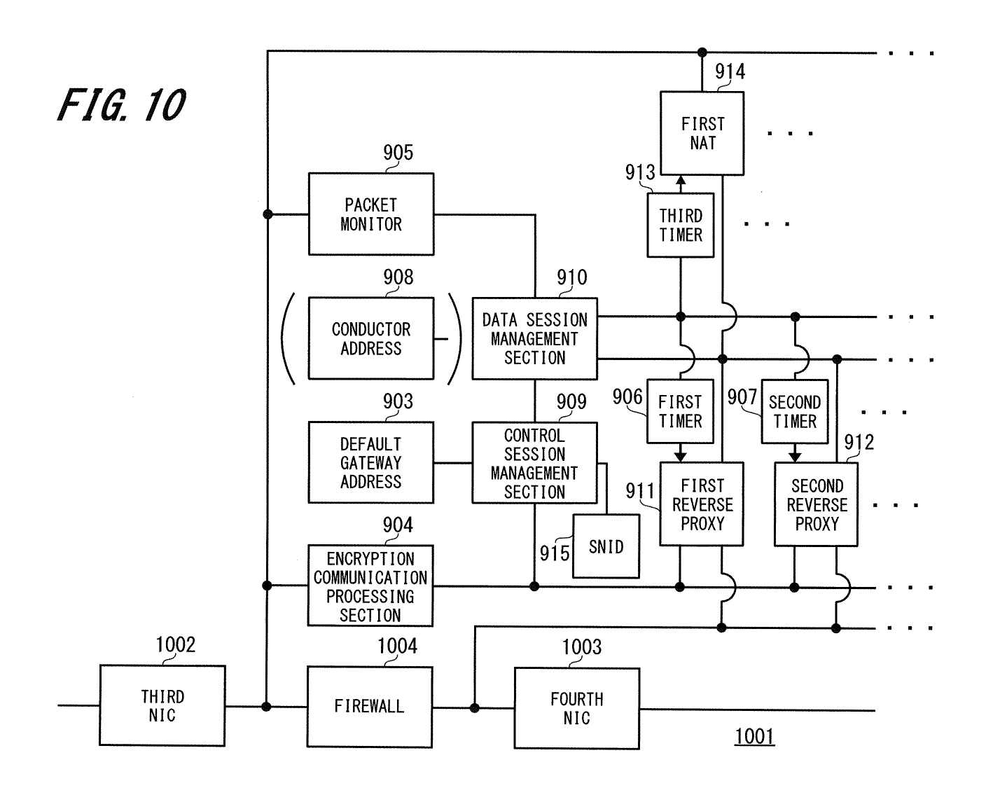

FIG. 10 is a functional block diagram of another stepping node. Different from the stepping node 901 shown in FIG. 9, a stepping node 1001 shown in FIG. 10 is a device with a firewall.

The stepping node 1001 of the present embodiment is arranged between two subnets adjacent to each other and different from each other in the LAN 102, and also serves as a gateway between two IP directly unreachable stepping nodes 1001, or between the stepping node 1001 and the server 103.

A fixed IP address is assigned to a third NIC 1002 connected to the LAN 102.

A fixed IP address, which is different from that of the third NIC 1002, is assigned to a fourth NIC 1003 connected to the LAN 102.

A firewall 1004 is provided between the third NIC 1002 and the fourth NIC 1003, wherein the firewall 1004 has a dynamic NAT function for connecting a host (such as the terminal, the server 103 or the like) connected to the subnet on the side of the fourth NIC 1003 to the subnet on the side of the third NIC 1002, and a packet filtering function for protecting the host on the fourth NIC 1003 from the security threat of the network.

The stepping node 1001 shown in FIG. 10 is particularly preferred to be provided as a firewall for connecting a company LAN to the Internet. In such case, the network on the side of the third NIC 1002 is the Internet, and the network on the side of the fourth NIC 1003 is the company LAN. Further, the IP address of the fourth NIC 1003 is the gateway address of the company LAN.

The operation of the stepping node 1001 shown in FIG. 10 is identical to the operation of the stepping node 1001 except for the existence of the firewall 1004 and the fourth NIC 1003. The reverse proxy activated by the data session management section 910, such as the first reverse proxy 911, the second reverse proxy 912 or the like, achieves communication between the server 103 and the local master or the stepping node 1001, wherein the server 103 is arranged on the side of the fourth NIC 1003, and the local master is arranged on the side of the third NIC 1002. The static NAT set by the data session management section 910, such as the first NAT 914 or the like, achieves communication between the local master provided on the side of the third NIC 1002 and the stepping node 1001, or communication between two stepping nodes 1001.

If the terminal is simply to be connected to the server 103 existing on the other side of the firewall 1004, the reverse proxy may be set for the gateway of the LAN 102 or for the device arranged on the border between the LAN 102 and the Internet 107. However, in such a case, the terminal is connected to the IP address of a machine where the reverse proxy operates. However, such connection state raises a concern that various adverse effects may be caused due to the security setting originally existed in the application.

To be specific, for example, the web browser “Internet Explorer” (referred to as “IE” hereinafter) installed as standard on a Windows (trademark) of Microsoft Corporation is provided with a function of changing the security setting that determines whether or not to execute a script embedded in a HTML (Hyper Text Markup Language) file or an external application based on a host name excluding the IP address, FQDN (Full Qualified Domain Name) or domain name of the web server to be connected. The web application of the web server in the LAN 102 is created based on an assumption that the web server is to be accessed by terminals in the LAN 102; while in the web server in the Internet, since convenience should be given priority, the HTML files also includes scripts and the like which are risky and therefore must not be executed. In other words, if only the reverse proxy is provided, even if the terminal is connected to the server 103 within the LAN 102 from the Internet, there is no guarantee that a desired application, such as the IE, can normally operate, and further, there is a strong possibility that problems, such as abnormal end and the like, might be caused.

To solve the aforesaid problems, a mechanism for “creating an illusion that seems like the terminal is connected to the server in the LAN” needs to be provided to the applications operating on the terminal, such as the IE and the like. The solution to solve the aforesaid problems is a static NAT. Connecting the terminal to the server 103 through the static NAT means connecting the terminal to the private address of the same subnet as the terminal in the case of the local master box 109, or means connecting the terminal to the loopback address in the case of the soft local master 113. In any cases, when viewed from the IE, the destination IP address assigned to the packet belongs to a “local intranet” capable of reducing the level of the security setting of the application. In such a manner, the terminal can pass through the Internet 107 to access the server 103 existing on the other side of the firewall 1004, as if the terminal accesses the server 103 in a “local intranet” with no restriction in security setting.

The advantages of rewriting the IP address are not limited to the aforesaid examples.

There may be cases where two companies merged with each other, or two companies (or organizations) form a business tie-up with each other, so that their LANs need to be connected with each other. In such cases, since the LANs of the two companies are not configured based on a premise that the two companies will merge with each other, there is a possibility that the private IP addresses used in their LANs might duplicate each other.

In the case of a provider that provides network service to a plurality of companies and organizations, the possibility that IP addresses of the LANs of these companies and organizations might duplicate will be dramatically increased. It is inefficient to change the connection of the network every time performing maintenance service in order to avoid IP address duplication.

With the network system of the present embodiment, by converting the IP address using the static NAT and the reverse proxy and virtualizing the network connection, it is not necessary to worry about IP address duplication when connecting a plurality of networks.

[Conductor 115]

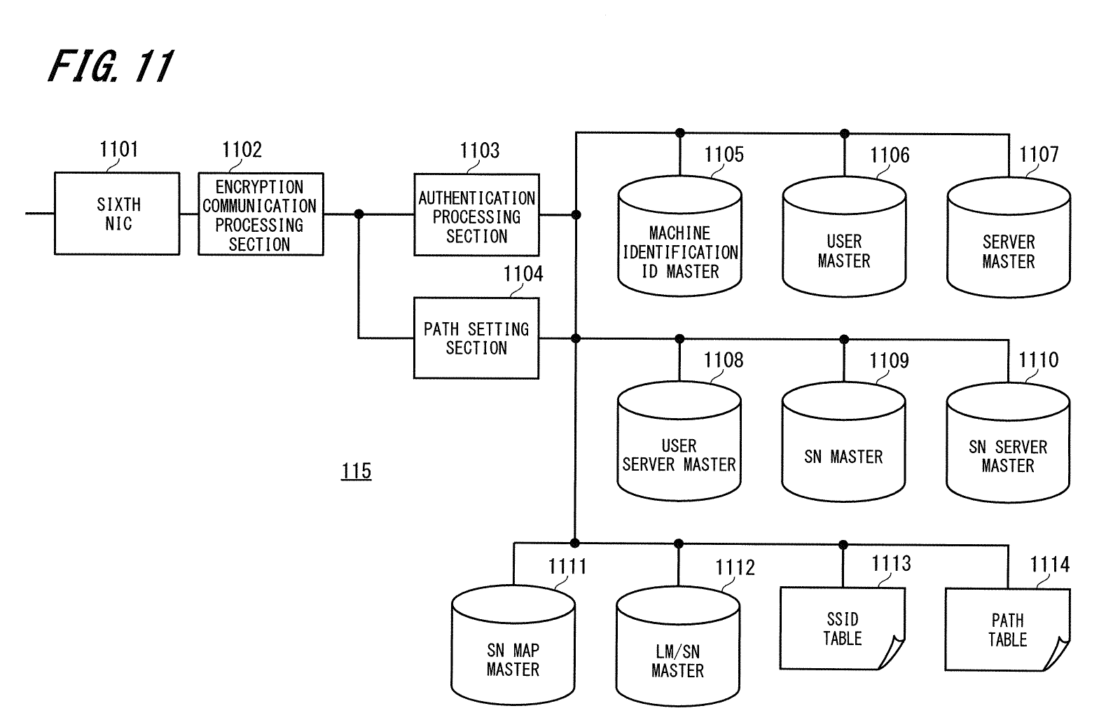

FIG. 11 is a functional block diagram of the conductor 115.

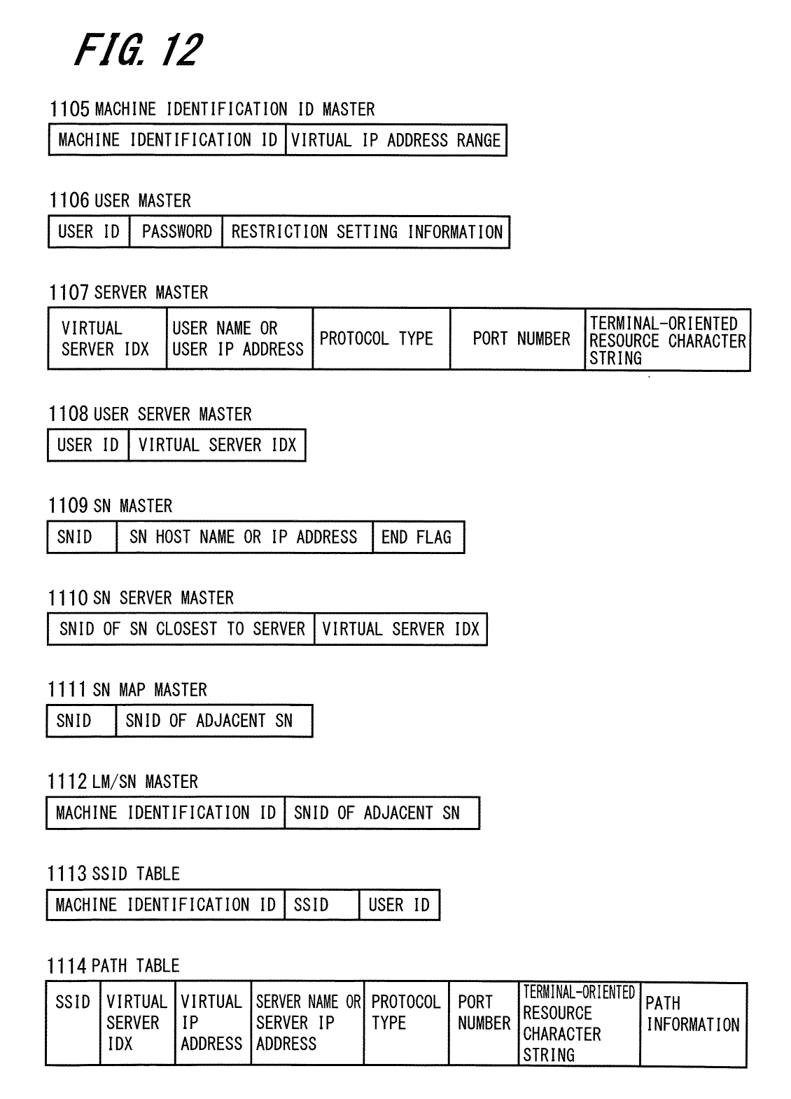

FIG. 12 is a view showing the field configuration of tables included in the conductor 115.

The conductor 115 of the present embodiment is specified to perform communication with the player 111 and the local master through the control session. Different from the stepping node, the conductor 115 does not form data session.

The conductor 115 is a computer operated by a network OS. As an example, it is preferred that a POSIX-compliant OS, such as Linux (trademark), is used as the OS.

A fixed IP address is assigned to a sixth NIC 1101 connected to the LAN 102.

An encryption communication processing section 1102 connected to the sixth NIC 1101 is paired with the encryption communication processing section 606 provided to the local master box 109 or the soft local master 113. In other words, the encryption communication processing section 904 transmits/receives the authentication information to/from the local master, and encrypts the control session.

An authentication processing section 1103 refers to a machine identification ID master 1105 and a user master 1106 to perform the machine authentication and the personal authentication. Further, with respect to the local master which has succeeded at performing machine authentication, the authentication processing section 1103, instead of the machine identification ID, generates a so-called SSID (which is authentication information that varies from one session to another), and writes the pair of the machine identification ID and the SSID in a SSID table 1113. Further, with respect to the player 111 which has succeeded at performing personal authentication, the authentication processing section 1103 writes the pair of the SSID and a user ID in the SSID table 1113. In other words, in the case where the machine authentication and the personal authentication have been normally completed, a record of the set of the machine identification ID, the SSID and the user ID is formed in the SSID table 1113, wherein the machine identification ID, the SSID and the user ID are associated with each other. Further, the machine authentication and the personal authentication can be performed by proxy by performing a SSID authentication.

A path setting section 1104 uses a SN server master 1110, a SN map master 1111 and a LM/SN master 1112 to create the path information, and records the path information in a path table 1114. Further, the path setting section 1104 refers to the machine identification ID master 1105 to describe a virtual IP address in the path table 1114.

The machine identification ID master 1105 is a table in which the machine identification ID of the local master whose connection is permitted by the conductor 115, and the virtual IP address range are listed.

The virtual IP address range is a range of the IP addresses tried to be accessed by the application program while the application program of the terminal is trying to access the server 103.

The network system 101 of the present embodiment is adapted to virtually connect an IP directly unreachable terminal to a server by a VPC tunnel.

When the application program is to access the server 103, it accesses the virtual IP address, instead of accessing the original IP address assigned to the server 103. The virtual IP address is assigned to the local master, which is IP reachable from the terminal.

In the case of the local master box 109 shown in FIG. 6, the virtual IP address belongs to the subnet of the second NIC 601. For example, in the case where the subnet of the second NIC 601 is 192.168.1.0/24 and the IP address of the second NIC 601 is 192.168.1.2, an IP address in a range from 192.168.1.1 to 192.168.1.254 can be used as the virtual IP address.

In the case of the soft local master 113 shown in FIG. 7, the virtual IP address belongs to the subnet of the loopback virtual NIC 701. For almost all network OS, 127.0.0.1 is assigned to the loopback virtual NIC 701, and the subnet is 127.0.0.0/8, therefore an IP address in a range from 127.0.0.1 to 127.255.255.254 can be used as the virtual IP address.

The virtual IP address range field of the machine identification ID master 1105 is set so that, based on the configuration of the local master, the optimal virtual IP address can be provided to the local master and, eventually, to the terminal. When transmitting the service menu information 614 to the user, the setting of the virtual IP address is described from the range written in the virtual IP address range field.

The personal authentication information and the restriction setting information of the user whose connection is permitted by the conductor 115 are stored in the user master 1106, wherein personal authentication information of the user includes the user ID, the password and the like.

The virtual server IDX, the server name or server IP address, the protocol type of the protocol used to access the server 103, the port number, the terminal-oriented resource character string and the like are stored in a server master 1107.

The virtual server IDX is information for uniquely identifying the record of the server master 1107. This is because that there may be the same subnets existing in different bases, and servers which provide the same IP address and same service respectively may exist in the subnets, so that index information for uniquely identifying the server is provided instead of the server name and the like.

Further, the virtual server IDX is information included in the service menu information 614; and, in a VPC establishment sequence, the virtual server IDX is included the command for the local master to make a request to the conductor 115 for creating the VPC tunnel, wherein the VPC establishment sequence is started in response to the connection request transmitted by the application of the terminal to the server 103.

The server name or server IP address, together with the port number, is information necessary for the stepping node closest to the server to connect to the server in an IP reachable manner. If name resolution can be done in the stepping node, the server name will be used. If name resolution can be done, the server name may be a FQDN, or only a host name. If name resolution can not be done, the IP address will be used.

The name of known protocol, such as RDP, HTTP, SSH or the like, or identification information equivalent to protocol name is stored in the protocol type field.

The port number means the port number to be used to access the server. In many cases, the port number is determined for each protocol. For example, if the protocol is HTTP, the port number will be 80; if the protocol is RDP, the port number will be 3389; if the protocol is SSH, the port number will be 22; and if the protocol is VNC, the port number will be from 5900 to 5906. However, depending on the setting of the server, the setting, such as the port number, may be intentionally changed, and therefore the client needs to be set according to the setting of the server.

The terminal-oriented resource character string is a character string to be used, when the terminal is accessing the server, for the application program of the terminal to specify the information resource of the machine to be connected, and is also an argument of the application embedded in the icon provided by the dedicated shell of the player 111. For example, if the protocol is HTTP, the terminal-oriented resource character string will be a URL; and if the protocol is CIFS, the terminal-oriented resource character string will be a resource name, which shows the route by which the server provides resource.

In many cases, the server name or the server IP address is included in part or all of the terminal-oriented resource character string. Thus, there is a case where part or all of the terminal-oriented resource character string is substituted by a virtual IP address, depending on the type of the protocol.

For example, if the protocol is RDP or SSH, the terminal-oriented resource character string matches the server name or the server IP address. Thus, in the case where the protocol is RDP or SSH, the entire terminal-oriented resource character string will be substituted by a virtual IP address.

If the protocol is CIFS, there is a case where part of the terminal-oriented resource character string matches the server name or the server IP address. Thus, in the case where the protocol is CIFS, a part of the terminal-oriented resource character string will be substituted by a virtual IP address.

If the protocol is HTTP, since there is a strong possibility that the web browser may be connected to an unspecified number of web servers based on the hyperlink embedded in an html file, the setting items of the proxy server of the web browser include setting the virtual IP address of the VPC tunnel. If the web browser is set in such a manner, the web browser will just transmit the terminal-oriented resource character string to the VPC tunnel (which is the proxy server) without performing name resolution. The actual operation for acquiring the web content is performed by the reverse proxy operated by the stepping node closest to the web server. Thus, in the case where the protocol is HTTP, the terminal-oriented resource character string will not be substituted by the virtual IP address.

The user ID and the virtual server IDX of the server 103 possible to be used by the user who owns the user ID are stored in pair in a user server master 1108. Thus, the record acquired by narrowing down the user server master 1108 with the user ID to obtain the virtual server IDX and searching the server master 1107 with the obtained virtual server IDX as a search key includes the server 103 possible to be used by the user, and the information necessary for using the server 103.

A SN master 1109 is a table formed by the SNID for uniquely identifying the stepping node, the host name of the stepping node (i.e., the SN host name) or the IP address, and an end flag which shows whether or not there is a server in a range IP reachable from the stepping node.

When using the SN server master 1110, the SN map master 1111 and the LM/SN master 1112 (which are to be described later) to create the path information, the path setting section 1104 creates original data of the path information with the SNID. Finally, the path setting section 1104 converts the SNID into the host name or the IP address to complete the path information, and transmits the path information to the local master.

The SN server master 1110 is a table formed by the SNID of the stepping node closest to the server, and the virtual server IDX, wherein the SNID and the virtual server IDX are formed in pair.

The stepping node closest to the server is the stepping node where the value of the end flag field of the SN master 1109 is logical “true”.

The number of stepping node(s) IP reachable from one server does not have to be one. In other words, there may be a plurality of stepping nodes possible to be reached from a certain server. Further, the number of the IP reachable servers with respect to one stepping node does not have to be one. In other words, there may be a plurality of servers possible to be reached from a certain stepping node. In other words, there may be a plurality of paths each for a certain local master to reach a certain server.

In such a network, the distance of the network is important factor for judging how the optimal path should be selected, but more important factor is the traffic of the network.

The network system 101 of the present embodiment is designed so that there may be a plurality of stepping nodes IP reachable from a certain server. The SN server master 1110 is a table that describes the relationship between the server(s) and the IP reachable stepping node(s).

If the VPC tunnel can be switched so that, when the load of a stepping node possible to be reached from a certain server becomes large, the server is reached from other stepping node, then it will be possible to instantly and suitably distribute the load of the network.

The SN map master 1111 is a table formed by pair(s) of the SNID(s) of stepping node(s) and the SNID(s) of stepping node(s) adjacent to the stepping node(s).

When searching the SN map master 1111 with the SNID of a certain stepping node, the SNID(s) of all stepping node(s) adjacent to the stepping node can be obtained.

The LM/SN master 1112 is a table formed by pair(s) of the machine identification ID(s) of local master(s) and the SNID(s) of the stepping node(s) adjacent to the local master.

When searching the LM/SN master 1112 with the SNID of a certain local master, the SNID(s) of all stepping node(s) adjacent to the local master can be obtained.

The path setting section 1104 uses a known path searching algorithm, such as Dijkstra algorithm, to create the path information for the local master to reach the server. At this time, the SNID(s) of all stepping node(s) toward the originating local master are obtained by using the LM/SN master 1112. Similarly, the SNID(s) of all stepping node(s) toward the target server, as well as the virtual server IDX(s) corresponding to the SNID(s), are obtained by using the SN server master 1110. A plurality of combinations of starting point and ending point are created, and then the optimal path information for each combination is created. Further, a piece of optimal path information is selected based on the traffic information separately reported from the stepping node, and/or the like.

Incidentally, there is also an alternative method in which, in a LAN with a simple configuration, a plurality of pieces of path information are previously created, and the optimal path information is read out and returned when there is a request for acquiring path information coming from the local master.

The path table 1114 is a table formed by a group of data, which are the SSID, the virtual server IDX, the virtual IP address, the server name or server IP address, the protocol type, the port number, and the path information.

When the terminal has completed the personal authentication and then, made a request for acquiring the service menu information 614, the authentication processing section 1103 searches the SSID table 1113 with the SSID transmitted from the terminal to acquire the corresponding user ID. Next, the authentication processing section 1103 searches the user server master 1108 with the user ID to create a list of the virtual server IDX(s) of the server(s) 103 possible to be used by the user. Further, the authentication processing section 1103 searches the server master 1107 with the list of information of the virtual server IDX(s) as a search key to form information necessary for the user to use the server(s) 103 possible to be used by the user. Further, the authentication processing section 1103 queries the path setting section 1104 to calculate the optimal path information at the current moment, and adds the optimal path information to the search result of the server master 1107. This is the service menu information 614.

Although not shown in FIGS. 11 and 12, the service menu information 614 is a table formed by a group of data, which are the SSID, the virtual server IDX, the virtual IP address, the server name or server IP address, the protocol type, the port number, and the terminal-oriented resource character string.

In response to the request for acquiring the service menu information made by the terminal (the player 111), the conductor 115 forms the service menu information 614. The formed service menu information 614 is once stored in the path table 1114. At this time, the column of the path information is kept blank. Further, the service menu information 614 is returned to the terminal which has made the request.

Next, in response to the request for acquiring the path information made by the local master, the conductor 115 causes the path setting section 1104 to operate to create the path information. Since the local master has transmitted the SSID and the virtual server IDX, the conductor 115 searches for the stepping node(s) adjacent to the server with the virtual server IDX as a search key, and searches the SSID table 1113 with the SSID as a search key for acquiring the machine identification ID 608, and searches the LM/SN master 1112 for acquiring the stepping node adjacent to the local master with the machine identification ID 608 as a search key. Upon having calculated the optimal path information by using the SN map master 1111, the conductor 115 writes the path information into the path information field of the path table 1114, and returns the path information to the local master.

When the local master has transmitted a command to request for creating the VPC tunnel, a static NAT will be set for the stepping node(s) existing in the path information based on the path information included in the command. Further, when the command has reached the stepping node closest to the server, the stepping node will perform authentication again with the conductor 115, and make a request for acquiring information that shows detail information of the server. The conductor 115 returns the information necessary for the stepping node to set the reverse proxy, the information including the host name or IP address of the server, the protocol type, and the port number.

Incidentally, in order to distinguish between the query coming from the local master and the query coming from the stepping node closest to the server, the conductor 115 confirms whether or not a SNID is included in the query.

If no SNID is included in the query, it will known that the query is a query coming from the local master, and therefore the conductor 115 returns the path information.

While if a SNID is included in the query, it will be known that the query is a query coming from the stepping node closest to the server, and therefore the conductor 115 returns the host name or IP address of the server, the protocol type and the port number.

As can be known from the above description, the conductor 115 performs double authentications (i.e., the machine authentication and the personal authentication) with respect to the local master, and forms a control session between the conductor 115 and the local master. Further, in order to achieve connection between the user who operates the terminal and the server 103, the conductor 115 forms the path information for the local master to reach the target server 103 through the proper stepping node(s) according to the request made by the terminal, and transmits the path information to the local master.

In the steps for forming the VPC tunnel, the SSID authentication is respectively performed for the local master (which is the beginning of the VPC tunnel) and the stepping node (which is located at the end of the VPC tunnel). When the SSID authentication of the local master has been completed, the conductor 115 transmits the path information to the local master. When the SSID authentication of the stepping node has been completed, in order to set the reverse proxy to connect to the server 103, the conductor 115 transmits the information of the server 103 to the stepping node.

[Summary of Operation]

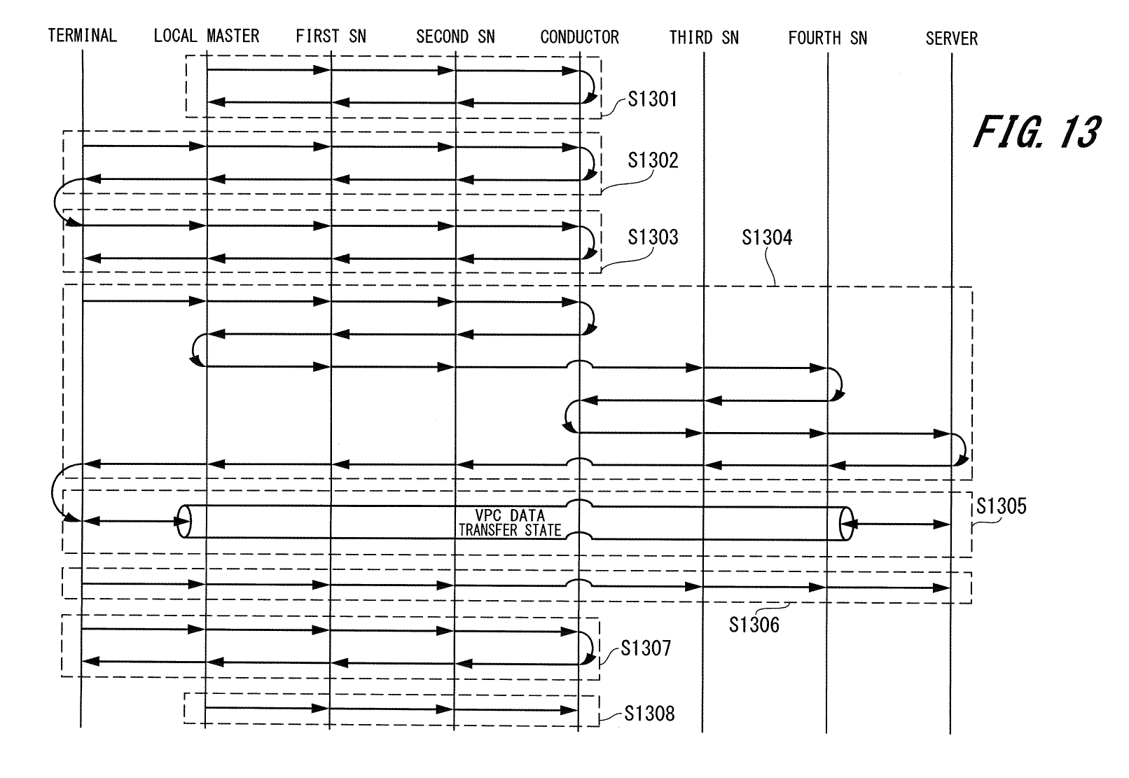

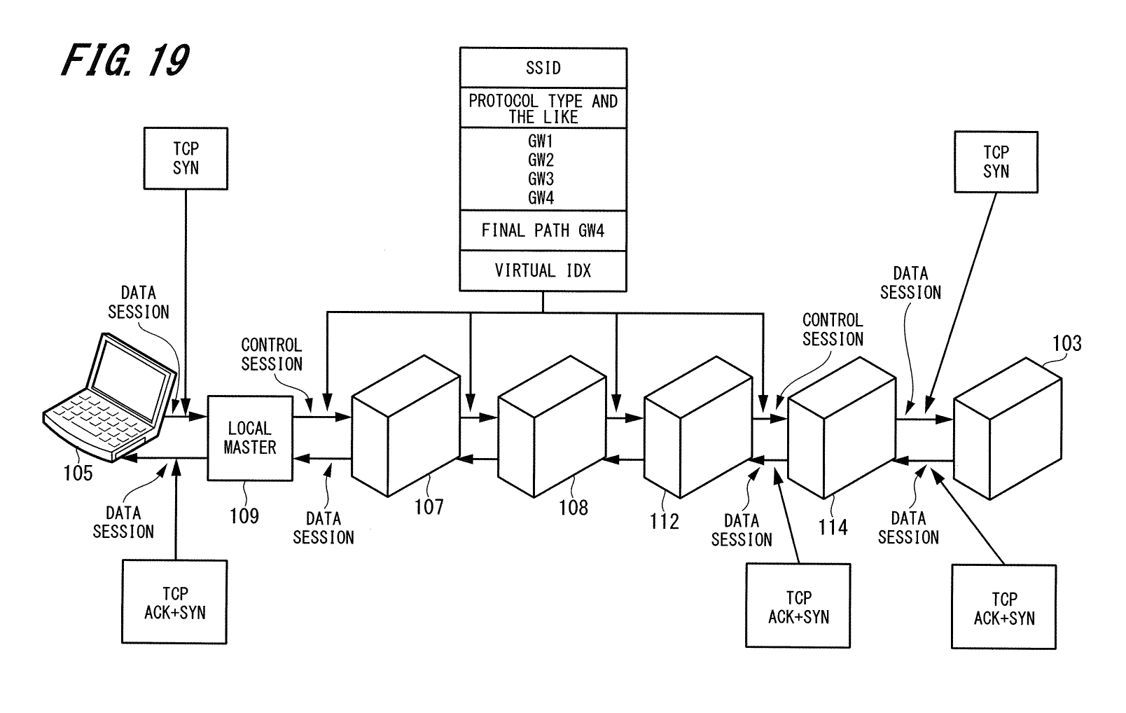

FIG. 13 to FIG. 21, except for FIG. 19, show timing diagrams for explaining the flow of the operations from the operation of connecting the terminal to the server 103 remotely-positioned in the network so that the source of the server 103 becomes available, to the operation of terminating the service later, in the network system 101 of the present embodiment.

First, the flow of the operation will be described below.

FIG. 13 is a timing diagram for explaining the flow of the whole operation of the network system 101 of the embodiment.

When the local master is started, it immediately tries to authenticate the machine identification ID 608 with the conductor 115, through the control session. Such operation is referred to as a machine identification ID authentication sequence (S1301).

When the local master has succeeded at performing authentication of the machine identification ID 608 in the machine identification ID authentication sequence, the player 111 of the terminal displays the login screen on the display 206. In such a state, the user performs the personal authentication. The personal authentication information is transmitted to the conductor 115 through the control session, and the authentication result is returned to the player 111 of the terminal. Such operation is referred to as a personal authentication sequence (S1302).

When the personal authentication sequence has normally terminated, the player 111 immediately makes a request to the conductor 115 through the control session for acquiring the service menu information 614. The conductor 115 returns the service menu information 614 and the restriction setting information 610 to the player 111. Such operation is referred to as a menu acquiring sequence (S1303).

When the user performs an operation such as clicks the icon shown on the screen of the terminal, an application program described in the command line character string embedded in the icon will be executed. The application program transmits a connection request packet (i.e., a TCP SYN packet) to the local master. Upon confirming the connection request packet, the local master makes a request to the conductor 115 for the path information through the control session. The conductor 115 returns the path information to the local master. The conductor 115 creates a VPC establishment request command that includes the received path information, and transmits the VPC establishment request command to the stepping node(s) through the control session according to the path information. The conductor 115 transmits the VPC establishment request command to the stepping node(s) described in the path information except for the last stepping node, and sets a static NAT for forming VPC, i.e., the static NAT for forming the data session. When the last stepping node described in the path information has recognized that itself is the stepping node located at the end of the path indicated by the path information, it will query the conductor about the information on the server to be connected, and acquire the IP address, the port number and the protocol type of the server from the conductor. Based on such information, the last stepping node described in the path information suitably performs reverse proxy. Further, the connection request packet coming from the terminal reaches the server 103 owing to the last stepping node described in the path information. The response packet returned by the server 103 fixes the temporarily formed VPC tunnel, and reaches the terminal. Such operation is referred to as a VPC establishment sequence (S1304).

After the VPC establishment sequence has been performed, the formed VPC tunnel is used to perform communication between the terminal and the server 103 in a virtual connection state. Such state is referred to as a VPC data transfer state (S1305).

Basically, the VPC tunnel is destroyed by transmitting information which shows active termination of the terminal. Such operation is referred to as a VPC cutting sequence (S1306).

When the user wants to stop using the terminal, the user declares logout. The logout declaration is transmitted to the conductor 115 through the control session, and returned to the terminal. Such operation is referred to as a user logout sequence (S1307).

When the operation of the local master is terminated by turning off the power of the local master box 109 through the terminal or by shutting down the terminal on which the soft local master 113 is installed, such information is notified to the conductor 115. Such operation is referred to as local master shutdown (S1308).

[Machine Identification ID Authentication Sequence]

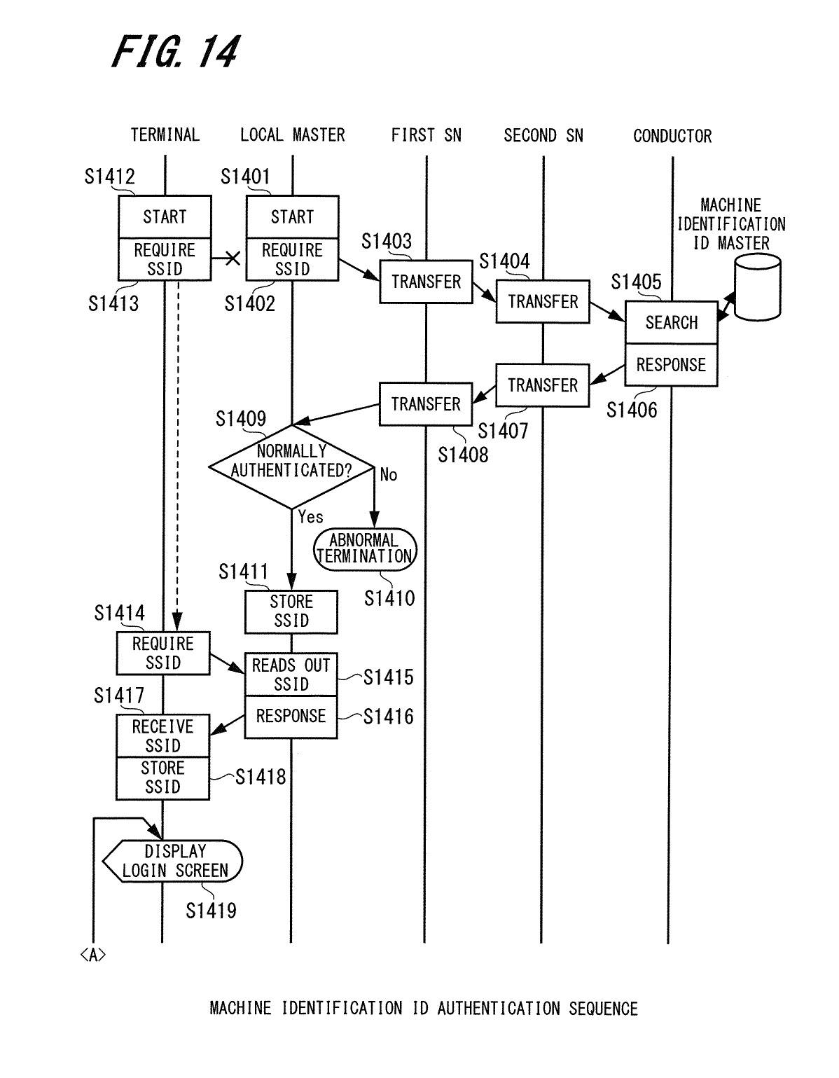

FIG. 14 is a timing diagram for explaining the machine identification ID authentication sequence. FIG. 14 shows the details of the step S1301 of FIG. 13.

When the local master is started (S1401) and recognizes that it is connected to the LAN 102 and becomes IP reachable from the LAN 102, the local master immediately transmits an authentication request of the machine identification ID 608 to the conductor 115 through the control session (S1402).

The local master does not directly know the address of the conductor 115. However, while the conductor 115 is performing first terminal 105, the host name or IP address of the “default gateway”, which indicates which IP reachable stepping node should try to be communicated with, is held in the local master. In the present embodiment, the default gateway is the first SN 107. The local master transmits the machine authentication request, with the conductor 115, to the first SN 107 through the control session.

When the first SN 107 has received the authentication request of the machine identification ID 608 from the local master, the control session management section 609 recognizes that the authentication request is a request to the conductor 115. Further, the first SN 107 transfers the authentication request of the machine identification ID 608 to the stepping node (the second SN 108 in the present embodiment) described in the default gateway address 612 (S1403).

The second SN 108 is IP reachable from the conductor 115. Thus, different from the local master box 109 and the first SN 107, instead of the “default gateway”, the second SN 108 holds the host name or IP address of the conductor 115 in the conductor address 908.

Similar to the first SN 107, upon receiving the authentication request of the machine identification ID 608 from the first SN 107, the second SN 108 transfers the authentication request of the machine identification ID 608 to the conductor 115 described in the conductor address 908. In such a manner, the conductor 115 receives the authentication request of the machine identification ID 608 transmitted by the local master.

The conductor 115 searches the machine identification ID master 1105 with the machine identification ID 608 of the local master received from the second SN 108 to confirm whether or not the machine identification ID 608 is information described by a formal local master. The search result (i.e., the machine identification ID authentication result) is returned to the machine from which the last transmission is received, i.e., the second SN 108 (S1406).

The control session management section 609 of the second SN 108 transfers the machine identification ID authentication result received from the conductor 115 to the first SN 107 (S1407).

The control session management section 609 of the first SN 107 transfers the machine identification ID authentication result received from the second SN 108 to the local master (S1408).

The local master views the machine identification ID authentication result received from the first SN 107 to confirm whether or not the authentication has been normally performed (S1409). If the authentication could not be normally performed (“NO” in S1409), then abnormal termination will be caused, and after that no operation can be performed (S1410). If the authentication has been normally performed (“YES” in S1409), the control session management section 609 of the local master will store the SSID included in the machine identification ID authentication result in the SSID memory 613 (S1411).

On the other hand, when the player 111 of the terminal is started (S1412), it will make a request to the local master for transferring the SSID.

In the case where the local master has not acquired and stored the SSID from the conductor 115, the request for transferring the SSID will fail (S1413); however, after the local master has acquired the SSID from the conductor 115 and stored the SSID therein, since the local master reads out the SSID stored in the SSID memory 613 in response to the request for transferring the SSID (S1415) and replies the terminal (S1416), the player 111 receives the SSID (S1417) and stores the SSID therein (S1418).

Incidentally, in the case of the soft local master 113, since the SSID memory 613 is shared by the player 111, the steps S1417 and S1418 are omitted.

In response to the fact that the acquisition of the SSID has normally terminated, the player 111 displays the login screen on the display 206 (S1419).

The description given above is the machine identification ID authentication sequence.

After the machine identification ID authentication sequence has terminated normally, instead of the local master transmitting the machine identification ID 608, the local master can be identified by the SSID. The machine identification ID 608 is fixed; however, the SSID varies every time the local master starts, and therefore security is improved.

[Personal Authentication Sequence and Menu Acquiring Sequence]

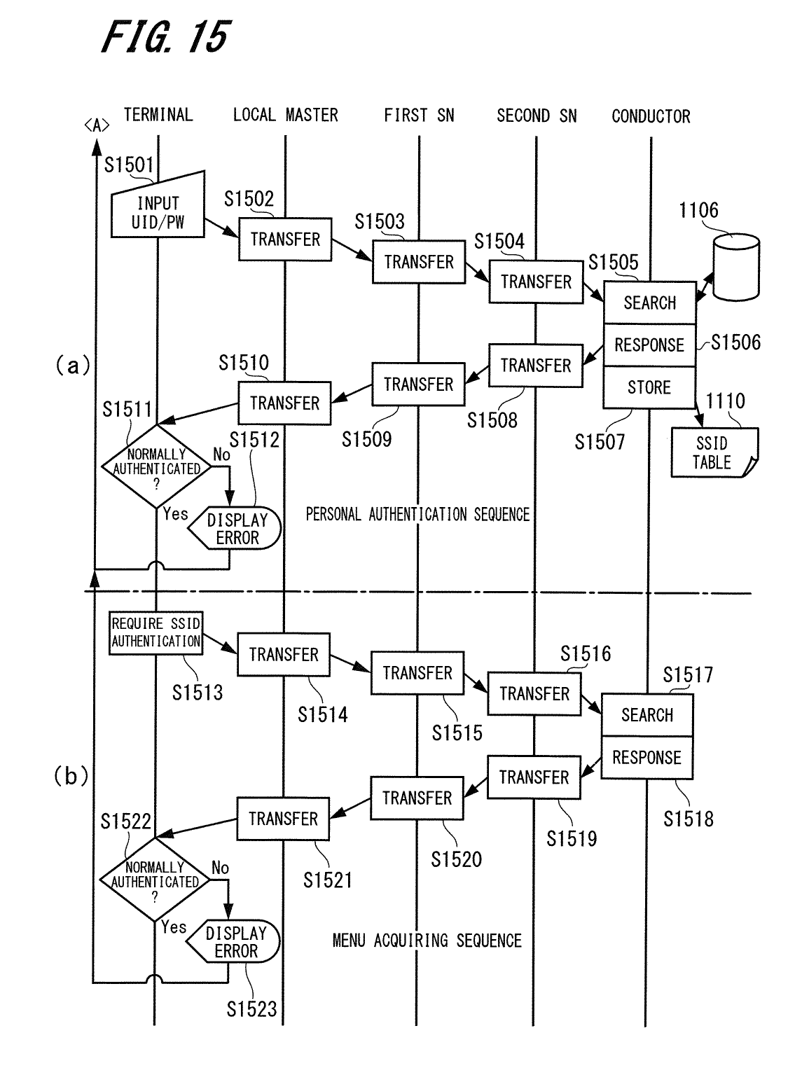

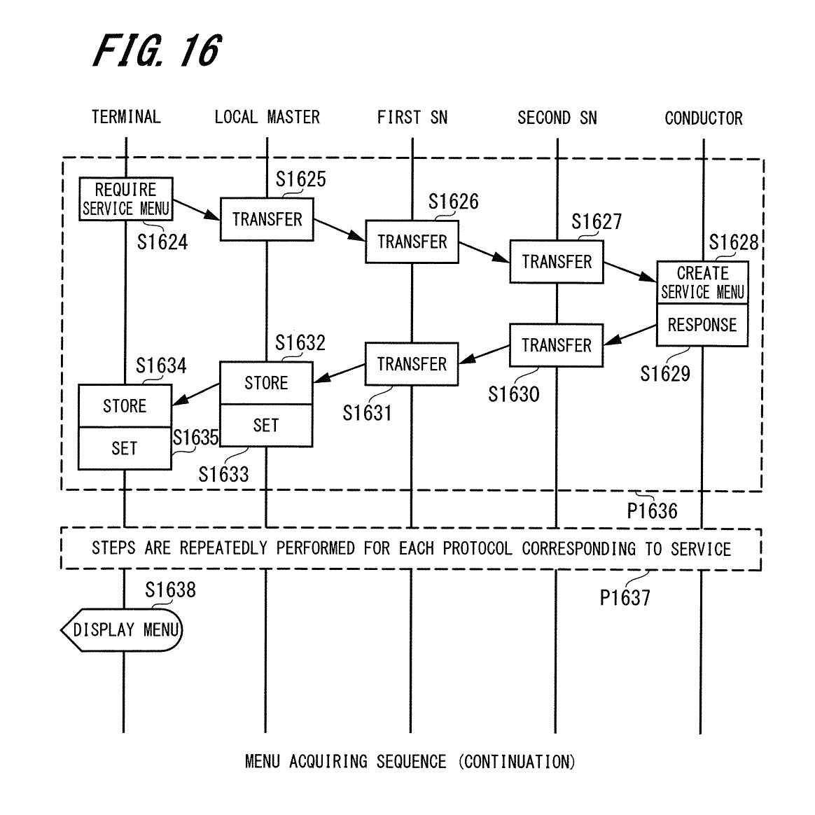

FIG. 15 (a) and (b) are timing diagrams respectively for explaining the personal authentication sequence and the menu acquiring sequence. FIG. 16 is a timing diagram for explaining the menu acquiring sequence. The timing diagram of FIG. 16 shows the details of the step S1302 of FIG. 13.

FIG. 15 (a) shows the personal authentication sequence.

The user operates the IC card reader 104, the keyboard or the like of the terminal to input the personal authentication information such as the user ID, the password and the like. The personal authentication information, together with the SSID, is transferred by the player 111 to the local master through the control session (S1501).

The local master transfers the personal authentication information and SSID received from the player 111 to the first SN 107 according to the default gateway address 612 (S1502).

The first SN 107 transfers the personal authentication information and SSID received from the local master to the second SN 108 according to the default gateway address 612 (S1503).

The second SN 108 transfers the personal authentication information and SSID received from the first SN 107 to the conductor 115 according to the conductor address 908 (S1504).

The conductor 115, which has received personal authentication information and SSID from the second SN 108, searches the user master 1106 with the personal authentication information (S1505), and returns the search result (i.e., the user ID authentication result) to the machine from which the last transmission is received, i.e., the second SN 108 (S1506). If the user ID authentication result is normal, the user ID will be stored in the SSID table 1113 (S1507).

The second SN 108 transfers the user ID authentication result received from the conductor 115 to the first SN 107 (S1508).

The first SN 107 transfers the user ID authentication result received from the second SN 108 to the local master (S1509).

The local master transfers the user ID authentication result received from the first SN 107 to the terminal (S1510).

The player 111 of the terminal views the user ID authentication result received from the local master to confirm whether or not the authentication has been normally performed (S1511). If the authentication could not be normally performed (“NO” in S1511), an error message will be displayed on the display 206 (S1512), and then the login screen will be displayed (S1419 of FIG. 14).

If the authentication has been normally performed (“YES” in S1511), the operation will transfer to the menu acquiring sequence.

The description given above is the personal authentication sequence.

After the personal authentication sequence has normally terminated, (in step S1507) the user ID and the SSID are associated with each other (i.e., to make it clear “who is using which terminal”). Thus, when performing the SSID authentication, both the machine identification and the personal authentication can be performed at the same time. The personal authentication information is fixed; however, the SSID varies every time the local master starts, and therefore security is improved.

FIG. 15 (b) shows the menu acquiring sequence.

The player 111 of the terminal views the user ID authentication result received from the local master to confirm whether or not the authentication has been normally performed (S1511), and if the authentication has been normally performed (“YES” in S1511), the player 111 will first make a request to the conductor 115 through the control session for authenticating the SSID (S1513).

The SSID authentication request is transferred from the player 111 to the local master (S1514), from the local master to the first SN 107 (S1515), and from the first SN 107 to the second SN 108 (S1516), so as to reach the conductor 115. The conductor 115 searches the SSID table 1113 with the received SSID (S1517), and returns the search result (i.e., the SSID authentication result) to the machine from which the last transmission is received, i.e., the second SN 108 (S1518).

The SSID authentication request returned from the conductor 115 is transmitted from conductor 115 to the second SN 108 (S1519), from the second SN 108 to the first SN 107 (S1520), and from the first SN 107 to the local master (S1521), so as to be returned to the terminal.

The player 111 of the terminal views the SSID authentication result received from the local master to confirm whether or not the authentication has been normally performed (S1522). If the authentication could not be normally performed (“NO” in S1522), an error message will be displayed on the display 206 (S1523), and then the login screen will be displayed (S1419 of FIG. 14).

The description of the menu acquiring sequence will be continued with reference to FIG. 16.

If the authentication has been performed normally (“YES” in S1511) in the Step S1511, the player 111 will make a request to the conductor 115 for transmitting the service menu information 614 (S1624).

The request for the service menu information is transmitted from the player 111 to the local master (S1625), from the local master to the first SN 107 (S1626), and from the first SN 107 to the second SN 108 (S1627), so as to reach the conductor 115. The conductor 115 searches the SSID table 1113, the user server master 1108 and the server master 1107 (S1628), and returns the search result (i.e., the service menu information 614) to the machine from which the last transmission is received, i.e., the second SN 108 (S1629). Incidentally, at this time, the restriction setting information 610 is also read out from the user master 1106 and returned together with the service menu information 614.

The service menu information 614 and the restriction setting information 610 returned from the conductor 115 are transferred from the conductor 115 to the second SN 108 (S1630), and transferred, from the second SN 108 to the first SN 107 (S1631).

Upon receiving the service menu information 614 and the restriction setting information 610 from the first SN 107, the local master stores service menu information 614 and the restriction setting information 610 therein, and transfers the service menu information 614 and the restriction setting information 610 to the terminal (S1632). Further, the local master performs various kinds of setting based on the service menu information 614 and the restriction setting information 610 (S1633).

Upon receiving the service menu information 614 and the restriction setting information 610 from the local master, the player 111 of the terminal stores the service menu information 614 and the restriction setting information 610 therein (S1634). Further, the player 111 performs various kinds of setting based on the service menu information 614 and the restriction setting information 610 (S1635).

The operations from the step S1624 to the step S1635 (P1636) are repeatedly performed for each protocol corresponding to the service (P1637). For example, if the protocol possible to be used by the user is RDP and HTTP, the step P1636 is performed for RDP, and then the step P1636 is performed for HTTP.

When the service menu information 614 corresponding to each service possible to be enjoyed by the user has been acquired for all services, the terminal displays the menu on the display 206 (S1638).

The description given above is the menu acquiring sequence.

[VPC Establishment Sequence and VPC Data Transfer State]

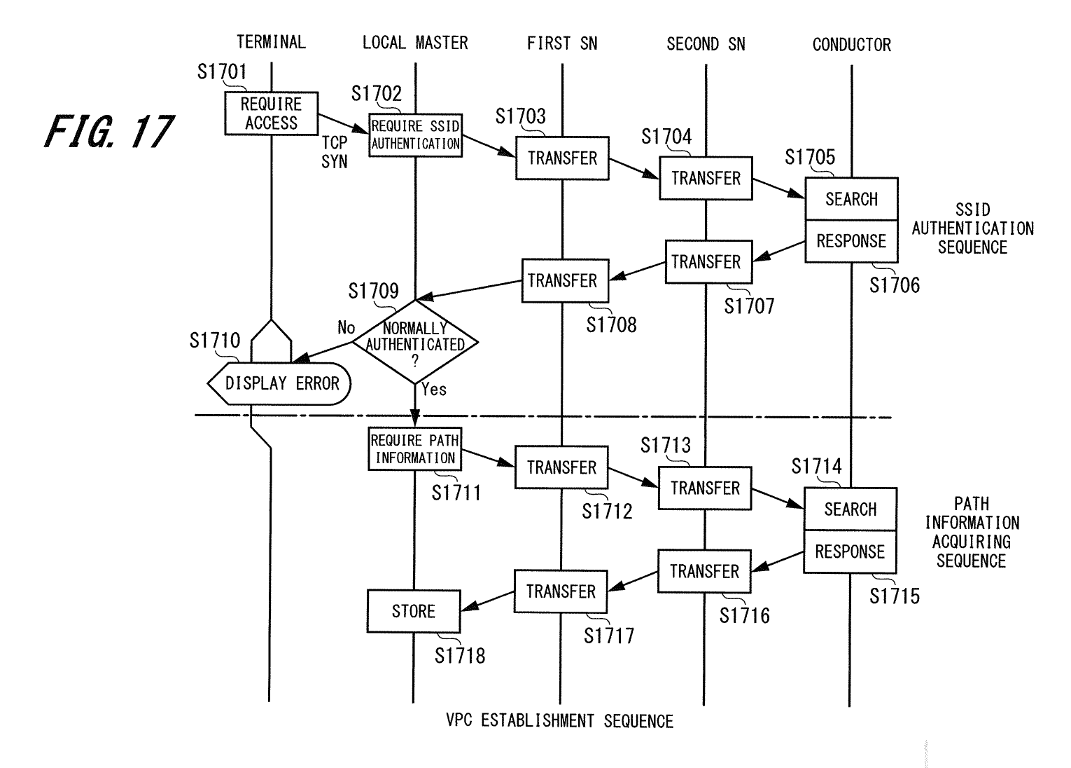

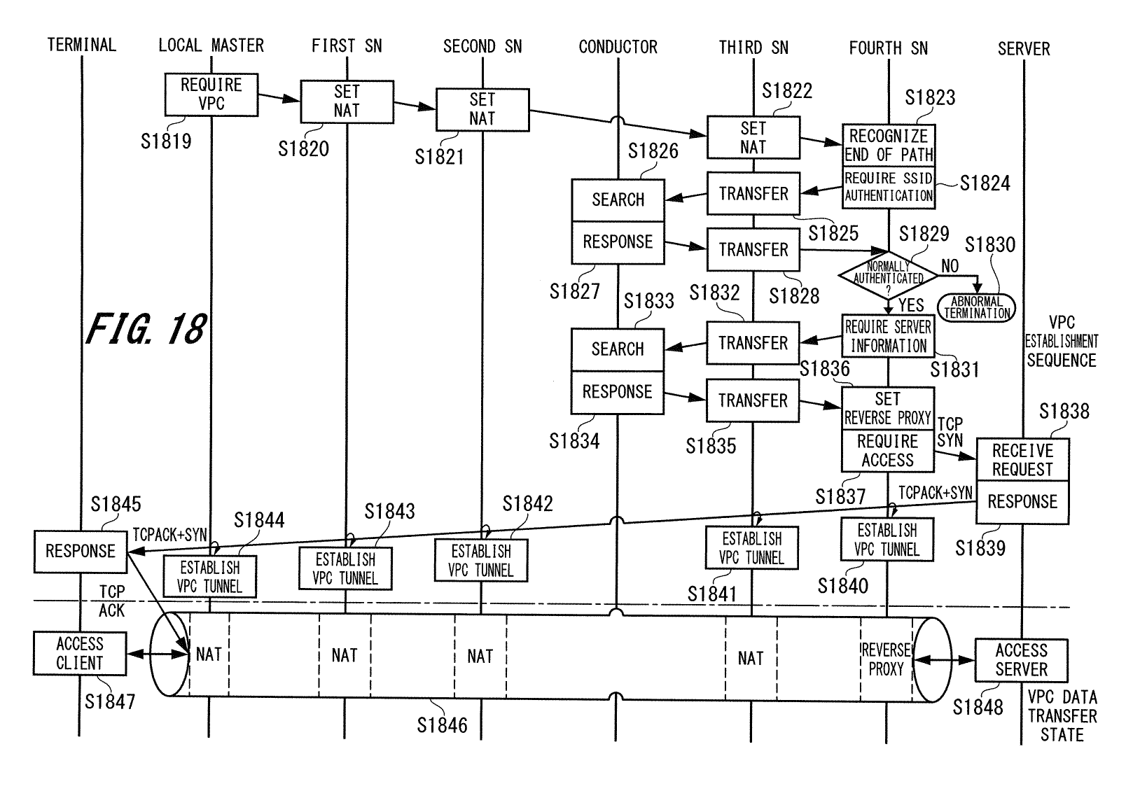

FIG. 17 is a timing diagram for explaining the VPC establishment sequence. FIG. 18 is a timing diagram for explaining the VPC establishment sequence and the VPC data transfer state. FIG. 17 and FIG. 18 show the step S1304 and the step S1305 of FIG. 13.

When the user operates the icon(s) formed by the dedicated shell 208 of the player 111 and displayed on the display 206 to start the application program, a TCP SYN packet will be generated from the application program (S1701). Upon capturing the TCP SYN packet, the packet monitoring section 615 of the local master discerns the server 103 requested by the application program and the protocol based on the destination IP address and port number of the TCP SYN packet. Further, the packet monitoring section 615 makes a request to the conductor 115 for acquiring the path information. However, since authentication is necessary before acquiring path information, the packet monitoring section 615 first makes a request to the conductor 115 for authenticating SSID.

In the step S1702, it is necessary for the packet monitoring section 615 of the local master to discern the server 103 requested by the application program and the protocol based on the destination IP address and port number of the TCP SYN packet. Thus, each record of the services listed in the service menu information 614 has to be unique for the combination(s) of the destination IP address(es) and the port number(s). In the case where services provided by a plurality of servers are to be provided to the user with one protocol, uniqueness of the service menu information 614 for each record is maintained by changing the virtual IP address or, if possible, changing the port number.

The SSID authentication request coming from the local master is transferred from the local master to the first SN 107 (S1703), and from the first SN 107 to the second SN 108 (S1704), so as to reach the conductor 115. The conductor 115 searches the SSID table 1113 (S1705), and returns the SSID authentication result (S1706). The SSID authentication request is transferred from the conductor 115 to the second SN 108 (S1707), and from the second SN 108 to the first SN 107 (S1708), so as to reach the local master.

If the SSID authentication result is an abnormal value (“NO” in S1709), the local master will report that effect to the terminal. In such a case, the terminal displays error on the display 206.

While if the SSID authentication result is a normal value (“YES” in S1709), the SSID authentication sequence, which begins with the step S1702, will terminate.

Upon recognizing that the SSID authentication sequence has normally terminated, the local master makes a request to the conductor 115 for acquiring the path information for reaching the target server 103 (S1711).

The request for acquiring the path information coming from the local master is transferred from the local master to the first SN 107 (S1712), and from the first SN 107 to the second SN 108 (S1713), so as to reach the conductor 115.

The path setting section 1104 of the conductor 115 uses a known path searching algorithm, such as Dijkstra algorithm, to create the path information for the local master to reach the server, and returns the path information (S1715). The path information is transferred from the conductor 115 to the second SN 108 (S1716), and from the second SN 108 to the first SN 107 (S1717), so as to reach the local master. The local master once stores the received path information in the RAM (S1718). At this time, the path information acquiring sequence, which begins with the step S1711, terminates.

The description of the VPC establishment sequence will be continued with reference to FIG. 18.

The local master creates the VPC establishment request command based on the path information received from the conductor 115, and transmits the VPC establishment request command to the first SN 107, which is the first stepping node, based on the path information (S1819).

Upon receiving the VPC establishment request command from the local master, the first SN 107 confirms whether or not itself is the end of the path indicated by the path information. Upon knowing that itself is not the end of the path indicated by the path information, the first SN 107 sets a static NAT between the local master and the second SN 108, which is located next to the first SN 107 according to the path information. Further, the first SN 107 transmits the VPC establishment request command to the second SN 108, which is the first stepping node, based on the path information (S1820).

Upon receiving the VPC establishment request command from the first SN 107, the second SN 108 confirms whether or not it is the end of the path indicated by the path information. Upon knowing that itself is not the end of the path indicated by the path information, the second SN 108 sets a static NAT between the first SN 107 and the third SN 112, which is located next to the second SN 108 according to the path information. Further, the second SN 108 transmits the VPC establishment request command to the third SN 112, which is the first stepping node, based on the path information (S1821).

Upon receiving the VPC establishment request command from the second SN 108, the third SN 112 confirms whether or not itself is the end of the path indicated by the path information. Upon knowing that itself is not the end of the path indicated by the path information, the third SN 112 sets a static NAT between the second SN 108 and the fourth SN 114, which is located next to the third SN 112 according to the path information. Further, the third SN 112 transmits the VPC establishment request command to the third SN 114, which is the first stepping node, based on the path information (S1822).

Upon receiving the VPC establishment request command from the third SN 112, the fourth SN 114 confirms whether or not itself is the end of the path indicated by the path information. Upon knowing that itself is the end of the path indicated by the path information (S1823), the fourth SN 114 uses the SSID included in the VPC establishment request command to make a request to the conductor 115 for acquiring SSID authentication (S1824).

The SSID authentication request coming from the fourth SN 114 is transferred by the third SN 112 (S1825), and reaches the conductor 115. The conductor 115 searches the SSID table 1113 (S1826), and returns the SSID authentication result (S1827). The SSID authentication request is transferred by the third SN 112 (S1828), and reaches the fourth SN 114.

If the SSID authentication result is an abnormal value (“NO” in S1829), the fourth SN 114 will terminate abnormally. In such a case, the NAT setting set by the first SN 107 in the step S1820, the second SN 108 in the step S1821 and the third SN 112 in the step S1822 will be cancelled due to time-out of the timer which has been set when performing the NAT setting.

While if the SSID authentication result is a normal value (“YES” in S1829), the fourth SN 114 will make a request to the conductor 115 for acquiring the IP address, the port number and the protocol type of the server 103, which are information necessary for setting the reverse proxy with respect to the target server 103 (S1831).

The server information coming from the fourth SN 114 is transferred by the third SN 112 (S1832), and reaches the conductor 115.

Upon receiving the server information request, the path setting section 1104 of the conductor 115 uses the virtual server IDX included in the server information request to search the path table 1114, and returns the IP address, the port number and the protocol type of the server 103 to the fourth SN 114 (S1834).

The server information transmitted by the conductor 115 is transferred by the third SN 112 (S1835), so as to reach the fourth SN 114.

The fourth SN 114 uses the IP address, the port number and the protocol type of the server 103 to set a reverse proxy between the third SN 112 and the server 103 (S1836). Further, the fourth SN 114 transmits a TCP SYN packet to the host name (or the IP address) and the port number of the server 103 (S1837).

In such a manner, the TCP SYN packet coming from the application program of the terminal in the step S1701 of FIG. 17 reaches the server 103 in the step S1838 of FIG. 18.

The server 103, which has received the TCP SYN packet from the fourth SN 114, returns a TCP ACK+SYN packet to the fourth SN 114 based on the well-known TCP three-way handshake, regardless of the VPC and the like (S1826). The TCP ACK+SYN packet passes through the data sessions (i.e., the VPC tunnels) temporarily set for the fourth SN 114, the third SN 112, the second SN 108, the first SN 107 and the local master (S1839 to S1845).

When the packet monitor 905 of the fourth SN 114 detects the TCP ACK+SYN packet passing through the data session, it reports that effect to the data session management section 910. The data session management section 910 stops the timer set for the pertinent reverse proxy to sustain the reverse proxy temporarily Performed in the step S1836 (S1840).

When the packet monitor 905 of the third SN 112 detects the TCP ACK+SYN packet passing through the data session, it reports that effect to the data session management section 910. The data session management section 910 stops the timer set for the pertinent static NAT to sustain the static NAT temporarily performed in the step S1822 (S1841).

When the packet monitor 905 of the second SN 108 detects the TCP ACK+SYN packet passing through the data session, it reports that effect to the data session management section 910. The data session management section 910 stops the timer set for the pertinent static NAT to sustain the static NAT temporarily performed in the step S1821 (S1842).

When the packet monitor 905 of the first SN 107 detects the TCP ACK+SYN packet passing through the data session, it reports that effect to the data session management section 910. The data session management section 910 stops the timer set to the pertinent static NAT to sustain the static NAT temporarily performed in the step S1820 (S1843).

When the packet monitoring section 615 of the local master detects the TCP ACK+SYN packet passing through the data session, it reports that effect to the control session management section 609. The control session management section 609 sustains the pertinent static NAT (S1844).

At this time, the VPC tunnels formed by the local master, the first SN 107, the second SN 108, the third SN 112 and the fourth SN 114, which exist between the terminal and the server 103, are fixed (S1846).

Upon receiving the TCP ACK+SYN packet returned from the server 103 through the VPC tunnel, the terminal returns a TCP ACK packet to the server 103 through the VPC tunnel based on the well-known TCP three-way handshake (S1845). Thereinafter, the terminal accesses the server 103 via the VPC tunnel and with the process according to TCP/IP fourth layer (an application) (S1847), and the server 103 also responses the access of the client in the same manner (S1848).

FIG. 19 is a view schematically showing the packet flowing in the VPC establishment sequence and the VPC establishment request command.

The TCP SYN packet transmitted from the first terminal 105 is transmitted with the data session.

Upon receiving the TCP SYN packet, the local master box 109 creates a VPC establishment request command, and transmits the VPC establishment request command to the first SN 107 through the control session.

The path information included in the VPC establishment request command is configured by the host name or IP address of the stepping node.

Upon receiving the VPC establishment request command received by the control session, the fourth SN 114 (which is the end of the stepping node that forms the VPC tunnel) transmits a TCP SYN packet from the data session to the server 103.

Upon receiving the TCP SYN packet, the server 103 returns a TCP ACK+SYN packet through the data session. The TCP ACK+SYN packet passes through the data sessions configured based on the reverse proxy and the static NAT having been temporarily formed for each stepping node (i.e., the VPC tunnels), and reaches the first terminal 105. Further, the TCP ACK+SYN packet sustains the temporarily set reverse proxy or static NAT of each stepping node.

As can be known from FIGS. 17, 18 and 19, the network system of the present embodiment interferes with the transfer of the first TCP SYN packet of the well-known TCP three-way handshake.

When detecting the TCP SYN packet (S1702), the local master makes a request to the conductor 115 for acquiring path information (S1711) after the SSID authentication sequence (S1702 to S1709).

Then, the conductor 115 creates the best path information at that time (S1714), and transmits the path information to the local master (S1715).

The local master transmits the VPC establishment command, which includes the path information, to the stepping node described in the beginning of the path information (S1819).

The stepping node which has received the VPC establishment command and which is not located at end of the path indicated by the path information transfers the command to the next stepping node according to the path information included in the command, and sets a static NAT in the data session (S1820, S1821 and S1822).

When the stepping node which has received the VPC establishment command and which is located at end of the path indicated by the path information recognizes that itself is located at end of the path indicated by the path information (S1823), the stepping node makes a request to the conductor 115 for acquiring server information (S1831) after the SSID authentication sequence (S1824 to S1829) has been performed using the SSID included in the VPC establishment command. Then, the conductor 115 searches for server information (S1833), and transmits the server information to the stepping node located at end of the path indicated by the path information (S1834).

The stepping node located at end of the path indicated by the path information sets a reverse proxy according to the server information (S1836), and transmits a TCP SYN packet to the server (S1837).

In a VPN based on a conventional technique, user authentication is performed through application programs to form a VPN tunnel. For this reason, if the number of the application programs to be connected to the VPN increases, the programs and the like for performing personal authentication corresponding to the application programs have to be prepared separately.

However, in the network system according to the present embodiment, the steps for forming the machine authentication, the personal authentication and the VPC tunnel are completely separated. If the machine authentication and the personal authentication in the first authentication step are successful, then the application programs connected to the server listed in the service menu information 614 can be accessed simply by accessing the resource described in the designated command line character string, without needing any special program. In the VPC establishment sequence, the authentication using the SSID is performed by the local master (which is the beginning of the VPC tunnel) and the stepping node located at the end of the VPC tunnel, and both the user and the application program need not to be conscious of such authentication.

[VPC Cutting Sequence]

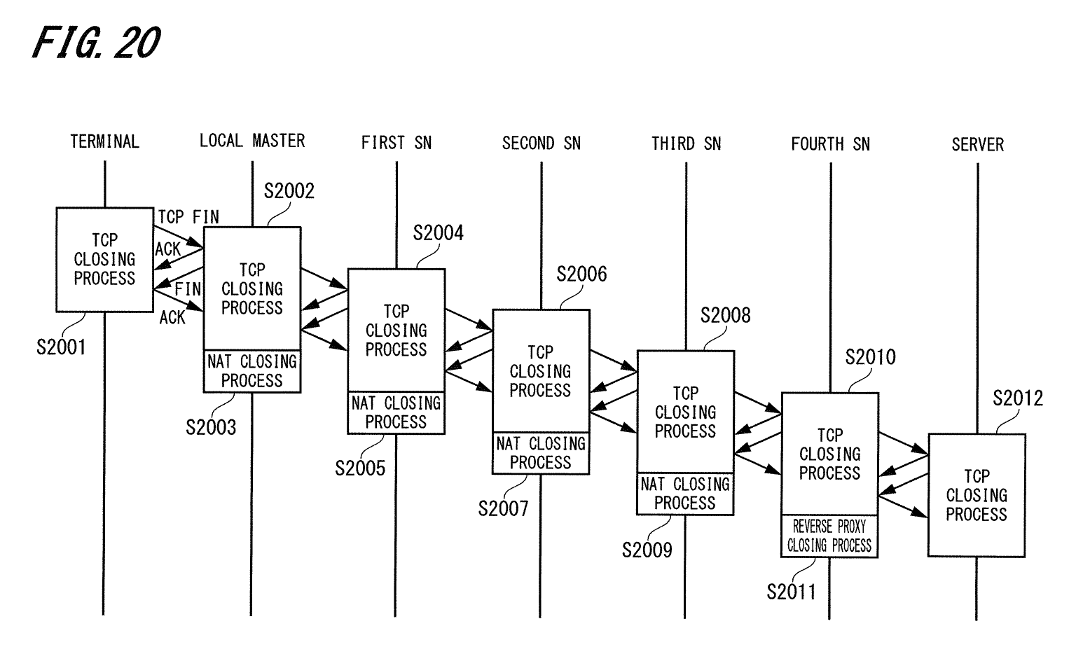

FIG. 20 is a timing diagram for explaining the VPC cutting sequence in the case where the protocol of the communication passing through the VPC tunnel is a connection type communication protocol. FIG. 20 shows the details of the step S1306 of FIG. 13.

In the case where the protocol of the communication passing through the VPC tunnel is a connectionless type protocol, such as HTTP, it is necessary to transfer all packets including the TCP FIN packet without delay; however, in the case where the protocol of the communication passing through the VPC tunnel is a connection type communication protocol such, as RDP and SSH, the fact that the TCP FIN packet is transmitted means that the application program has terminated. In other words, the termination of the VPC tunnel can be caused by monitoring a normal TCP communication terminating process, without needing to transmit a dedicated command for cutting the connection through the control session.

When the user operates the application program of the terminal to terminate communication, the application program performs the known TCP communication terminating process (S2001). At this time, when the TCP FIN packet transmitted by the application program reaches the local master, the local master also performs the TCP communication terminating process (S2002). When the TCP communication terminating process is completed, the local master cancels the static NAT by which the VPC tunnel has been formed (S2003).

The local master performs the TCP communication terminating process with respect to the first SN 107. At this time, when the TCP FIN packet transmitted by the local master reaches the first SN 107, the first SN 107 also performs the TCP communication terminating process (S2004). When the TCP communication terminating process is completed, the first SN 107 cancels the static NAT by which the VPC tunnel has been formed (S2005).

The first SN 107 performs the TCP communication terminating process with respect to the second SN 108. At this time, when the TCP FIN packet transmitted by the first SN 107 reaches the second SN 108, the second SN 108 also performs the TCP communication terminating process (S2006). When the TCP communication terminating process is completed, the second SN 108 cancels the static NAT by which the VPC tunnel has been formed (S2007).

The second SN 108 performs the TCP communication terminating process with respect to the third SN 112. At this time, when the TCP FIN packet transmitted by the second SN 108 reaches the third SN 112, the third SN 112 also performs the TCP communication terminating process (S2008). When the TCP communication terminating process is completed, the third SN 112 cancels the static NAT by which the VPC tunnel has been formed (S2009).

The third SN 112 performs the TCP communication terminating process with respect to the fourth SN 114. At this time, when the TCP FIN packet transmitted by the third SN 112 reaches the fourth SN 114, the fourth SN 114 also performs the TCP communication terminating process (S2010). When the TCP communication terminating process is completed, the fourth SN 114 cancels the reverse proxy by which the VPC tunnel has been formed (S2011).

The server 103 performs communication terminating process in response to TCP FIN packet transmitted from the fourth SN 114 (S2012)

[User Logout Sequence and Local Master Shutdown]

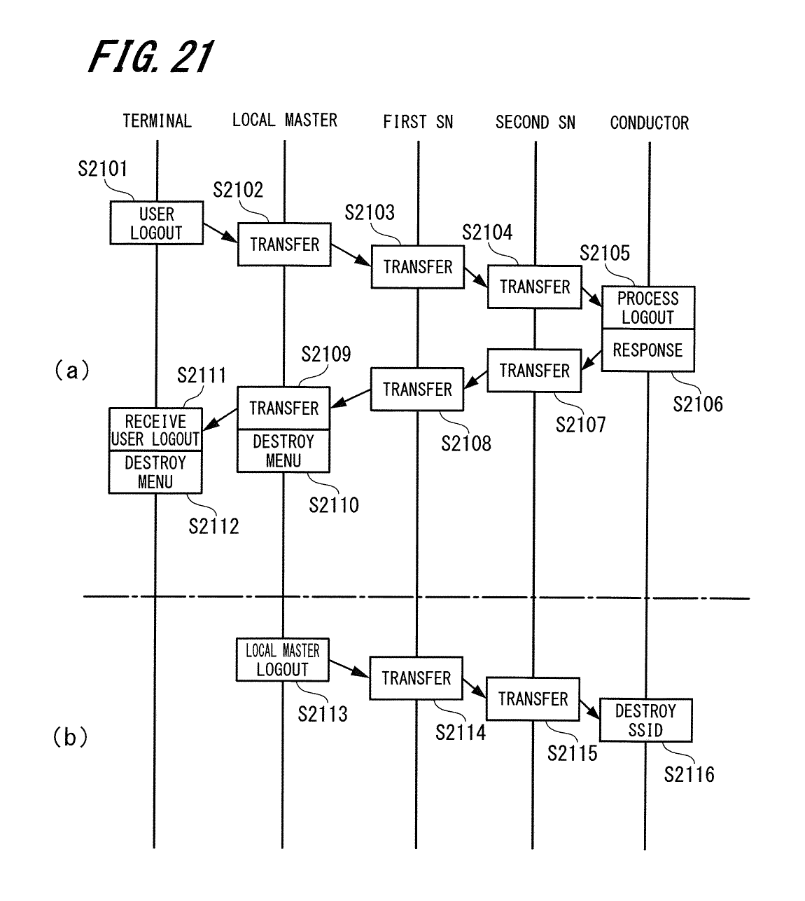

FIG. 21 (a) and (b) are timing diagrams for explaining the user logout sequence and the local master shutdown. FIG. 21 (a) and (b) show the details of the step S1307 and the step S1308 of FIG. 13.

When the user wants to stop using the terminal, he (or she) operates the dedicated shell 208 of the terminal to declare logout (S2101). The logout declaration is transmitted to the conductor 115 through the control session by being transferred from the terminal to the local master (S2102), from the local master to the first SN 107 (S2103), and from the first SN 107 to the second SN 108 (S2104), so as to reach the terminal (S2105). As user logout processing, the conductor 115 erases the user ID of the user described in the SSID table 1113 (S2105). In other words, the conductor 115 the association between the SSID and the user ID is released. A logout processing completion report is transmitted from the conductor 115 (S2106), and reaches the terminal (S2111) through the second SN 108 (S2107), the first SN 107 (S2108) and the local master (S2109).

At this time, upon receiving the user logout, the local master destroys the service menu information 614 and the restriction setting information 610 (S2110).

Similarly, upon receiving the user logout, the player 111 of the terminal destroys the service menu information 614 and the restriction setting information 610 (S2112).

When the operation of the local master is terminated (S2113) by turning off the power of the local master box 109 through the terminal or by shutting down the terminal on which the soft local master 113 is installed, such information is notified to the conductor 115 through the first SN 107 (S2114) and the second SN 108 (S2115). Upon receiving the notification, the conductor 115 erases the SSID of the SSID table 1113 (S2116).

It can be known from the above description that, in the network system 101 according to the present embodiment, when the application program of the terminal tries to connect to the server 103, a port different from the control session is first formed by the data session. Different data session will be formed every time the server to be connected by the terminal changes. Since the conductor 115 manages the resource of the server 103 possible to be used for each user with the path table 1114, it is possible to easily provide the virtual connection service to multiple users without causing troubles such as duplicated data session.

The present invention includes the following possible applications.

(1) The machine identification ID master 1105 and the user master 1106 of the conductor 115 may also refer to the authentication processing section 1103 through the network in the server 103 different from the conductor 115.

(2) The local master may access a plurality of conductors 115 at the same time. In such a case, immediately after completing the personal authentication, the local master needs to report the terminal target address assigned through the stepping node having been connected first to the stepping to be connected later, so that terminal target addresses do not duplicate each other in the respective stepping nodes.

(3) The soft local master 113 can be configured so as to have the same configuration as that of the local master box 109.

In the soft local master 113 shown in FIG. 7, the loopback virtual NIC 701 is used for the access using VPC; however, a NIC configured by software, such as the second NIC 601 of the local master box 109 shown in FIG. 6, can be used instead of the loopback virtual NIC 701. In the case of Windows (trademark), there are several examples of such software NIC, which include known programs such as the software product disclosed in Non-patent document 1, TAP-Win 32 (http://cipe-win32.sourceforge.net) and the like. In the case of Linux (trademark), such software NIC is provided in the driver of the kernel under the name of “universal. TUN/TAP device driver”.

(4) In the case where the terminal is a stationary terminal and therefore very unlikely to be moved from the LAN 102, the API hook processing section 813 of the player 111 may be caused to operate so that the behavior of the terminal is not restricted. In such a case, the player 111 is required to have a function of: holding the service menu information 614, and activating the dedicated shell 208.

(5) The stepping node may have no the function of starting the reverse proxy if there is no IP reachable server in the network to which the stepping node itself is connected.

The present embodiment discloses the network driver 806, and the static NAT forming device (i.e., the local master box 109 and the soft local master 113), the terminal management device (i.e., the player 111), the reverse proxy server (i.e., the stepping node) and the virtual network connection control device (i.e., the conductor 115) used in the network driver 806.

After the local master box 109 or the soft local master 113 and the stepping node have performed the machine authentication and the personal authentication through the control session, if the application program of the terminal has made a request for connecting the terminal to the server 103 in the private network existing before the conductor 115, the local master box 109 or the soft local master 113 and stepping node during the path will set a static NAT, and the stepping node closest to the server 103 will set a reverse proxy, so that a data session is formed between the terminal and the server. By configuring the network system 101 in such a manner, it is possible to achieve the connection the terminal and the server 103, which are not IP reachable from each other, in a virtual connection state without causing private address collision. Further, since the behavior of the terminal of the player 111 is strongly restricted, security vulnerability can be reduced.

Generally, a BSD Socket programming while configuring the server is created by opening a port for waiting the connection from a client and, when the client is connected, opening the port again for waiting the connection from another client. In other words, the server always has a particular port opened. The fact that the server always has a particular port opened may become a trigger for a malicious third party to explore vulnerability of the server program through the port.

In order to rule out the possibility that a third party might explore the vulnerability possibly existing in a plurality of reverse proxy programs corresponding to a plurality of protocols owned by the stepping node(s), the inventors of the present invention makes a port for actually connecting data with the terminal separately from the port always opened. Unlike the creating method of the server in the original BSD Socket programming, in the data session formed by the stepping node, even if a data session is established, the port will not be opened for the same data session. After all, the data session will not be formed, and a port for that purpose will not be opened, unless a connection request is made by the terminal. When the third party performs a port scanning on the stepping node, it seems like only the port for the control session is opened.

Further, the local masters connected to the network system 101 are each provided with a machine identification ID 608 for uniquely identifying each local master. Unlike the IP address, the machine identification ID 608 is only used as the authentication information in the control session.

Here, discussion will be made again for the packet flowed in the data session of the network system 101.

In the case of the soft local master 113, the sender's IP address of the packet coming from the terminal is the loopback address (127.0.0.1), and the recipient's IP address is an address (127.0.0.x) included in a class C subnet to which the loopback address belongs. In the case of the local master box 109, the sender's IP address is a private address (an example of which is 192.168.0.1), and the recipient's IP address is an address (192.168.0.x) included in a class C subnet to which the private address belongs.

In the soft local master 113 or the local master box 109, the sender's IP address and the recipient's IP address (and, if necessary, the port number) of these packets are rewritten by the static NAT. The sender's IP address is rewritten into an IP address assigned by the DHCP server to the soft local master 113 or the local master box 109, and the recipient's IP address and the port number are respectively rewritten into the IP address of the nearest stepping node and the port number for data session.

Further, these packets pass through a plurality of stepping nodes. The sender's IP address and the recipient's IP address (and, if necessary, the port number) of these packets are rewritten one after another by the static NAT or the reverse proxy set by the stepping nodes that constitute the VPC tunnel. The sender's IP address of the packet finally reaching the server 103 is rewritten into the IP address of the stepping node closest to the server 103, and the recipient's IP address and the port number of the same is respectively rewritten into the private address and the port number of the server 103.

In such a manner, the IP address of the packet passing through the communication channel is rewritten every time the packet passes through the base(s), and in such condition, the machine identification ID 608 is used for indicating the information “the terminal is entitled to be connected to the server 103”. Such information does not have to be owned by the server 103 that provide service to the terminal, as long as a machine for performing authentication (i.e., conductor 115) exists.

As is well known, we face the exhaustion of the address of IPv4, which is an urgent problem. Why IP address is being exhausted? The answer seems to be that the bit number of the IP address is not large enough. However, the fundamental reason for the problem is that the IP address which determines the destination of the packet that passes in the communication channel is made required to be unique for the terminal. Since the IP address is defined as a protocol and is a bit string having to be assigned to the packet, the IP address has to have a fixed length, and therefore it is not easily to extend the bit string. The inventors of the present invention think that is the source of the problem.

The information for requiring uniqueness of the terminal may only be used for requiring uniqueness of the terminal (i.e., for authentic act), and it should be unambiguously differentiated from the information for defining the destination of the packet. Based on such technical idea, the inventors of the present invention are negative in requiring uniqueness of the terminal from the IP address, and consider that the IP address is the information only used for the destination of the packet, and have tried to reconfigure a network system based on virtualization of communication channel and authentic act. That is the present embodiment.

The machine identification ID 608 included in the local master of the present embodiment is defined as a protocol, and is data only used for authentication, instead of being an IP address built as the header of the packet. Thus, no matter what action (such as extending the bit string, changing the format, or the like) is taken corresponding to the scale of the network driver 806 and according to necessity, since the format of the packet does not change, no problem will be raised. In the present embodiment, 12 bits were assigned to the machine identification ID 608 when the inventors of the present invention had made a prototype, obviously the bit-string may also be longer than 12 bits.

As can be known from FIG. 1 that, with the network system 101, it is possible to safely pass through between the subnets not IP reachable from each other by tracing the stepping nodes. By using such technique, even if a plurality of the same subnets exist in the path, the network system 101 may work as long as the plurality of the same subnets are not adjacent to each other. In other words, in principle, it is possible to configure a substantially infinitely wide network with the private IP address only.

As described above, the network system 101 has an aspect as technique for expanding the possibility of IPv4 protocol.

It is to be understood that, although the present invention is described based on the aforesaid embodiment, the present invention is not limited to the embodiment, and various modifications and applications can be made without departing from the spirit and scope of the present invention.

### EXPLANATION OF REFERENCE NUMERALS

101 network system
102 LAN
103 server
104 IC card reader
105 first terminal
106 second terminal
107 Internet
109 local master box
110 DHCP server
111 player
113 soft local master
115 conductor
201 network OS
202 shell
203 third application
204 storage
205 operating portion
206 display
207 built-in USB interface
208 dedicated shell
209 first application
210 second application
301 built-in NIC
403 USB-B connector
404 network connector
502 CPU
503 RAM
504 flash memory
505 USB interface
507 first NIC
508 bus
601 second NIC
602 DHCP client
603 address duplication preventing portion
604 DHCP server
605 NAT setting section
606 encryption communication processing section
608 machine identification ID
609 control session management section
610 restriction setting information
611 packet filter setting section
612 default gateway address
613 SSID memory
614 service menu information
615 packet monitoring section
701 loopback virtual NIC
702 DHCP client
705 NAT setting section
706 packet filter setting section
801 operation driver
802 display control section
803 file system
804 process control section
805 clipboard buffer
806 network driver
807 control session management section
808 operation information acquiring section
809 screen capture processing section
810 file system monitoring section
811 process monitoring section
812 clipboard monitoring section
813 API hook processing section
901 stepping node
902 fifth NIC
904 encryption communication processing section
905 packet monitor
906 first timer
907 second timer
908 conductor address
909 control session management section
910 data session management section
911 first reverse proxy
912 second reverse proxy
913 third timer
914 first NAT
915 SNID
1001 stepping node
1002 third NIC
1003 fourth NIC
1004 firewall
1101 sixth NIC
1102 encryption communication processing section
1103 authentication processing section
1104 path setting section
1105 machine identification ID master
1106 user master
1107 server master
1108 user server master
1109 SN master
1110 SN server master
1111 SN map master
1112 LM/SN master
1113 SSID table
1114 path table

1. A network system comprising:
a first network;
a terminal;
an application start control section arranged in the terminal and adapted to perform control so that an application program of the terminal accesses a virtual IP address;
a static NAT forming device arranged either in the terminal or between the terminal and the first network, and adapted to perform static NAT with respect to an access request made by the application program for accessing the virtual IP address;
a second network not IP reachable from the terminal;
a server arranged in the second network;
one or more reverse proxy server(s) arranged between the static NAT forming device and the server, each reverse proxy server being adapted to either operate a corresponding reverse proxy to transfer a packet transferred from the application program through the static NAT forming device to the server in the case where the reverse proxy server is IP reachable from the server, or transfer the packet transferred from the application program through the static NAT forming device to other IP reachable device by static NAT in the case where the reverse proxy server is not IP reachable from the server; and
a virtual connection control device adapted to perform communication with the application start control section and the static NAT forming device, and provide the path information formed by the one or more reverse proxy server(s) to the static NAT forming device.

2. The network system according to claim 1, wherein the static NAT forming device includes a machine identification ID capable of uniquely identifying each device, performs machine authentication using the machine identification ID when connecting to the virtual connection control device, and forms, if the machine authentication is successful, a control session for transmitting/receiving control information to/from the virtual connection control device.

3. The network system according to claim 2, wherein, after the static NAT forming device has completed the machine authentication, the application start control section forms a screen on the terminal for performing, with the virtual connection control device, personal authentication through the static NAT forming device.

4. The network system according to claim 2, wherein, after completing the machine authentication, the static NAT forming device further performs personal authentication for authenticating the user who uses the terminal, and, if the personal authentication is successful, the application start control section receives information of the server possible to be used by the user and the virtual IP address corresponding to the server from the virtual connection control device.

5. The network system according to claim 4,
wherein the terminal further comprises:
a storage;
a file system adapted to form files and directories in the storage; and
a process control section adapted to control the start and the termination of the application program,
wherein, based on restriction information received by the static NAT forming device from the virtual connection control device, the application start control section monitors the copying, moving, erasing and name changing of the files and/or directories with respect to the file system of the terminal, and monitors start of a particular process and self process hiding conduct with respect to the process control section of the terminal.

6. A virtual private connection forming method comprising:
a connection request step of transmitting a TCP SYN packet to a virtual IP address by which an application program of a terminal is associated with a server to be accessed;
a path information request step of making, after the TCP SYN packet has been captured, a request to a virtual connection control device for acquiring path information for forming a virtual network connection;
a virtual connection request step of transmitting, after the path information has been received, a virtual connection request command in the order of the reverse proxy servers listed in the path information, wherein the virtual connection request command includes the path information; and
a static NAT or reverse proxy forming step of either setting a static NAT if it is judged that the reverse proxy server having received the virtual connection request command is not the end of the path indicated in the path information, or activating a reverse proxy if it is judged that the reverse proxy server having received the virtual connection request command is the end of the path indicated in the path information.

7. The virtual private connection forming method according to claim 6, wherein the static NAT or reverse proxy forming step includes a server information acquiring step of acquiring, if it is judged that the reverse proxy server having received the virtual connection request command is the end of the path indicated in the path information, information of the server necessary for activating and setting the reverse proxy from the virtual connection control device, before activating the reverse proxy.

8. A static NAT forming device comprising:
a first NIC connected to a first network closest thereto;
a second NIC used for a terminal to perform connection using a static NAT to a server arranged in a second network not IP reachable from the first NIC; and
a NAT setting section arranged between the second NIC and the first NIC, and adapted to set the static NAT applied to a packet for the terminal to communicate with the server through the reverse proxy server existing in the second network.

9. The static NAT forming device according to claim 8, further comprising:
a machine identification ID capable of uniquely identifying each device; and
a control session management section adapted to, when connecting to the reverse proxy server, form a control session with respect to a virtual connection control device for performing a predetermined authentication step and perform machine authentication using the machine identification ID through the control session, and, if the machine authentication is successful, transmit/receive control information to/from the virtual connection control device through the virtual connection control device.

10. The static NAT forming device according to claim 9, wherein, after the machine authentication has been completed, the control session management section performs personal authentication for authenticating the user who uses the terminal, and, when the personal authentication is successful, receives information of the server possible to be used by the user and the virtual IP address corresponding to the server from the virtual connection control device.

11. A reverse proxy server comprising:
a first NIC connected to a network;
a control session management section adapted to form a control session for transmitting/receiving control information to/from the terminal; and
a data session management section adapted to activate a reverse proxy and form a data session between the reverse proxy and the terminal through the first NIC so as for the terminal to connect to a server, and set a static NAT and form a data session between the static NAT and the terminal through the first NIC so as for the terminal to connect to other device necessary for the terminal to reach the server.

12. A reverse proxy server comprising:
a first NIC connected to a network;
a second NIC connected to a network where there is a server to which a terminal tries connect;
a control session management section adapted to form a control session for transmitting/receiving control information to/from the terminal; and
a data session management section adapted to activate a reverse proxy and form a data session between the first NIC and the second NIC so as for the terminal to connect to a server, and set a static NAT and form a data session between the static NAT and the terminal through the first NIC so as for the terminal to connect to other device necessary for the terminal to reach the server.

13. A virtual connection control device comprising:
a machine identification ID master in which a machine identification ID included by a static NAT forming device is stored;
a user master in which personal authentication information of a user who uses a terminal either connected to the static NAT forming device or built into the static NAT forming device;
an authentication processing section adapted to receive the machine identification ID from the static NAT forming device to perform machine authentication using the machine identification ID master, and receive the personal authentication information of the user from the terminal to perform personal authentication using the user master; and
a path setting section adapted to create path information for performing virtual connection from the terminal to the server according to a request made by the static NAT forming device either connected to or built into the terminal which has normally completed the machine authentication and the personal authentication.

14. The virtual connection control device according to claim 14, wherein the machine identification ID master further has a range of the virtual IP address to which an application program performed in the terminal tries connect stored therein.
